(19) United States
(12) Patent Application Publication
(10) Pub. No.: US 2026/0319161 A1
(43) Pub. Date: Oct. 15, 2026

(54) LIGHTING DEVICE AND DISPLAY DEVICE

(71) Applicant: Shanghai Tianma Micro-Electronics Co., Ltd., Shanghai (CN)

(72) Inventors: Daisuke KUDO, Kawasaki (JP); Yukinori HASHIMOTO, Kawasaki (JP); Yuki ITO, Kawasaki (JP)

(73) Assignee: Shanghai Tianma Micro-Electronics Co., Ltd., Shanghai (CN)

(21) Appl. No.: 19/461,864

(22) Filed: Jan. 28, 2026

(30) Foreign Application Priority Data
Jan. 30, 2025 (JP) 2025-014341
Dec. 3, 2025 (JP) 2025-225964

(51) Int. Cl. F21V 8/00

(52) U.S. Cl. CPC G02B 6/0068; G02B 6/0055

(57) ABSTRACT

The present disclosure provides a lighting device and a display device. The lighting device includes a light guide plate, a light guide member, a first light source, and a second light source. The first light source emits visible light to be incident on the light guide plate. The second light source emits visible light to be incident on the light guide member. The light guide plate has a first light distribution control structure that is provided on a main surface with the exception of one partial area of the main surface. The light guide member has a second light distribution control structure that is provided in one partial area. The first light distribution control structure and the second light distribution control structure reflect or scatter visible light. The second light distribution control structure is capable of transmitting at least a portion of infrared light.

### CROSS-REFERENCE TO RELATED APPLICATIONS

This application claims the benefit of Japanese Patent Application No. 2025-14341, filed on Jan. 30, 2025, and Japanese Patent Application No. 2025-225964, filed on Dec. 3, 2025, of which the entirety of the disclosures is incorporated by reference herein.

### FIELD OF THE INVENTION

This application relates to a lighting device and a display device.

### BACKGROUND OF THE INVENTION

U.S. patent application publication No. 2009/0102763 discloses a display device in which a camera for imaging is integrated with a backlight panel. The disclosed display device includes a configuration in which the camera is arranged around a rear surface of a light guide plate, a configuration in which the camera is arranged on the liquid crystal panel side of the light guide plate, or a configuration in which an opening is made on the reflection sheet side of the light guide plate and the camera is arranged inside the opening.

In the display device in U.S. patent application publication No. 2009/0102763, the camera is visually recognized at the time of performing imaging and it becomes difficult to perform full screen display. In addition, in both the configuration in which the camera is arranged around the rear surface of the light guide plate and the configuration in which an opening is made on the reflection sheet side of the light guide plate, a pattern on the light guide plate itself or the reflection sheet is removed. In the configuration in which the camera is arranged on the liquid crystal panel side of the light guide plate, light emitted from the light guide plate is blocked by the camera. Therefore, in the full screen display at the time of non-imaging when imaging is not performed, since an area where the camera is installed becomes darker than the surroundings, brightness of the backlight becomes non-uniform.

### SUMMARY OF THE INVENTION

A lighting device according to a first aspect of the present disclosure includes: a light guide plate; a light guide member that is arranged in a direction perpendicular to a main surface of the light guide plate; a first light source that emits visible light to be incident on an edge surface of the light guide plate; and a second light source that emits visible light to be incident on the light guide member, the light guide plate is provided with a first light distribution control structure, the first light distribution control structure reflecting or scattering visible light incident on an edge surface from the first light source, on a main surface with the exception of one partial area of the main surface, and the light guide member is provided with a second light distribution control structure, the second light distribution control structure reflecting or scattering visible light incident from the second light source and being also capable of transmitting at least a portion of infrared light, in one partial area.

A lighting device according to a second aspect of the present disclosure includes: a first lighting that provides visible light to be emitted from a first area of a light emitting surface; a second lighting that provides visible light to be emitted from a second area of the light emitting surface, at least a portion of the second area being different from the first area of the light emitting surface; and an infrared camera capable of performing imaging using infrared light transmitted through the second area, and the second lighting includes a light guide member on which a light distribution control structure, the light distribution control structure reflecting or scattering incident visible light and emitting the visible light in a direction perpendicular to the light emitting surface, is provided corresponding to the second area.

A lighting device according to a third aspect of the present disclosure includes the lighting device according to the first aspect or the second aspect.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is an exploded perspective view illustrating a lighting unit and a display unit of a liquid crystal display device according to Embodiment 1;

FIG. 2 is a front view illustrating a light source unit of the liquid crystal display device according to Embodiment 1;

FIG. 3 is a cross-sectional view of the lighting unit and the light source unit;

FIG. 4 is a cross-sectional view illustrating diameters of through-holes;

FIG. 5A is a front view illustrating a configuration example of a rear chassis;

FIG. 5B is a front view illustrating a configuration example of a reflection sheet;

FIG. 5C is a front view illustrating a configuration example of an optical sheet;

FIG. 5D is a front view illustrating a configuration example of a first light guide plate;

FIG. 5E is a front view illustrating a configuration example of a second light guide plate;

FIG. 6A is a front view illustrating an arrangement example of second light emitting elements according to Embodiment 2;

FIG. 6B is a front view illustrating another arrangement example of the second light emitting elements according to Embodiment 2;

FIG. 6C is a front view illustrating still another arrangement example of the second light emitting elements according to Embodiment 2;

FIG. 6D is a front view illustrating still another arrangement example of the second light emitting elements according to Embodiment 2;

FIG. 6E is a front view illustrating still another arrangement example of the second light emitting elements according to Embodiment 2;

FIG. 6F is a front view illustrating still another arrangement example of the second light emitting elements according to Embodiment 2;

FIG. 7 is a cross-sectional view illustrating a configuration example in which an optical functional film according to Embodiment 3 is included;

FIG. 8 is a cross-sectional view illustrating a configuration example that includes a visible light diffusion film according to Embodiment 4;

FIG. 9A is cross-sectional view illustrating an arrangement of a first light guide plate and a second light guide plate according to Embodiment 5;

FIG. 9B is cross-sectional view illustrating another arrangement of the first light guide plate and the second light guide plate according to Embodiment 5;

FIG. 10 is a cross-sectional view illustrating a configuration example in which a light guide member and a plurality of second light emitting elements according to Embodiment 6 are included; and

FIG. 11 is a diagram illustrating a configuration example of a liquid crystal panel according to Embodiment 7.

### DETAILED DESCRIPTION OF THE INVENTION

The present disclosure is described below in detail, based on the drawings. Note that in the following description, terms indicating specific directions or positions are used as needed. Such terms are, for example, “right”, “left”, “up”, “down”, “front”, “rear”, and other terms that have similar meanings to the forgoing. Such terms are used for facilitating understanding of the present disclosure with reference to the drawings, and the technical scope of the present disclosure is not restricted by the meaning of those terms. In addition, parts designated by the same reference sign appearing in a plurality of drawings indicate the same or similar parts or members.

### Embodiment 1

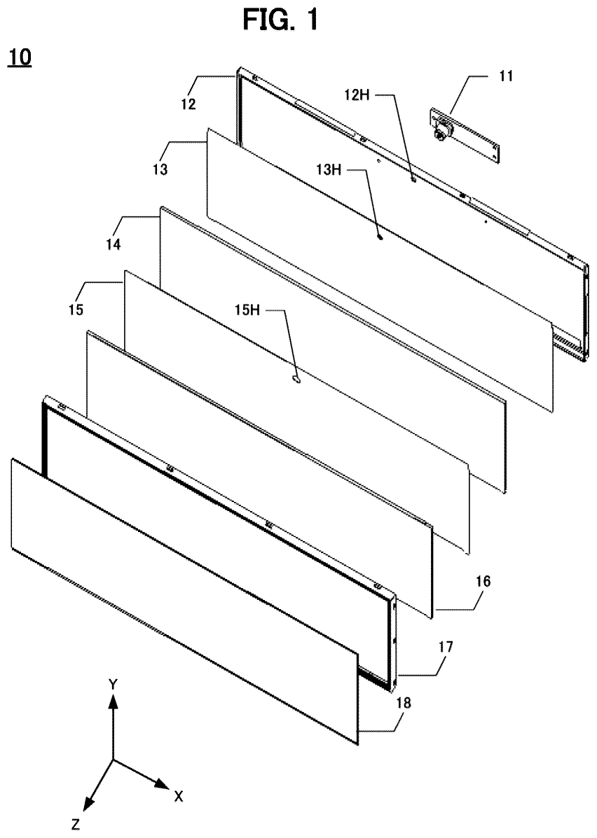

FIG. 1 is an exploded perspective view illustrating configurations of a lighting unit and a display unit included in a liquid crystal display device 10 of Embodiment 1. The liquid crystal display device 10 can be configured including an infrared camera 11, a rear chassis 12, a reflection sheet 13, a first light guide plate 14, an optical sheet 15, a second light guide plate 16, a front chassis 17, and a liquid crystal panel 18. Note that to facilitate understanding, FIG. 1 includes illustrations of an X-axis, a Y-axis, and a Z-axis. For example, it is assumed that on a main surface that is equivalent to a light emitting surface of the lighting unit and a display surface of the display unit in the liquid crystal display device 10 illustrated in FIG. 1, the right-left direction that is the horizontal direction is an X-axis direction and a direction pointing from the left side to the right side is a +X direction, and the up-down direction that is the vertical direction is a Y-axis direction and a direction pointing from the lower side to the upper side is a +Y direction. In addition, it is also assumed that the front-rear direction that is a normal direction to the main surface is a Z-axis direction and a direction pointing from the rear to the front is a +Z direction. Note that the forward side along the Z-axis direction is also referred to as a front side or a front face side. The rearward side along the Z-axis direction is also referred to as a rear side or a back face side. In other drawings, similar illustrations are also sometimes included as appropriate.

In the liquid crystal display device 10 illustrated in FIG. 1, the infrared camera 11 is arranged at a rearmost position on the −Z-direction side, the rear chassis 12, the reflection sheet 13, the first light guide plate 14, the optical sheet 15, the second light guide plate 16, and the front chassis 17 are arranged in this order from the rear to the front, and the liquid crystal panel 18 is arranged at a forwardmost position on the +Z-direction side. The lighting unit in the liquid crystal display device 10 illustrated in FIG. 1 is only required to be able to be configured including all or some of the reflection sheet 13, the first light guide plate 14, the optical sheet 15, and the second light guide plate 16. The lighting unit in the liquid crystal display device 10 is an edge light type backlight and is only required to be capable of emitting visible light from the light emitting surface. For example, light in a wavelength range of 380 nm or more and 780 nm or less is defined to be visible light.

The display unit in the liquid crystal display device 10 illustrated in FIG. 1 is only required to be able to be configured including the liquid crystal panel 18 in conjunction with the lighting unit. The display unit in the liquid crystal display device 10 is only required to be able to display an image on the display surface by the liquid crystal panel 18 serving as a display panel, using visible light from the lighting unit.

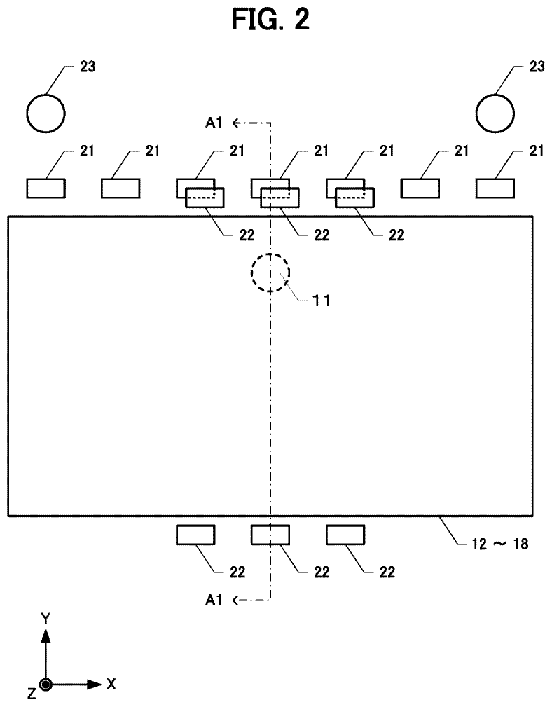

FIG. 2 is a front view illustrating constituent components of a light source unit included in the liquid crystal display device 10. The light source unit of the liquid crystal display device 10 can be configured including a plurality of first light emitting elements 21, a plurality of second light emitting elements 22, and one or a plurality of infrared light sources 23. The one or plurality of infrared light sources 23 outputs infrared light and irradiates an object to be imaged, such as a driver of a vehicle, with the infrared light. In the example illustrated in FIG. 2, two infrared light sources 23 are arranged on the right and left sides over the lighting unit and the display unit included in the liquid crystal display device 10. An arrangement of the infrared light sources 23 can be arbitrarily designed, and the infrared light sources 23 may be integrated with the liquid crystal display device 10 or may be arranged separately from the liquid crystal display device 10.

The plurality of first light emitting elements 21 illustrated in FIG. 2 is arranged in a line from the left end to the right end along the X-axis direction that is the right-left direction over the first light guide plate 14. The first light emitting elements 21 are, for example, light-emitting diodes and emit visible light. Note, however, that the first light emitting elements 21 are not limited to light-emitting diodes, and an arbitrary configuration capable of emitting visible light is applicable. Visible light emitted in the −Y-direction that is the downward direction from the first light emitting elements 21 is incident on an edge surface toward the inside of the first light guide plate 14. As described above, the plurality of first light emitting elements 21 constitutes a first light source that emits visible light to be incident on an edge surface of the first light guide plate 14.

The plurality of second light emitting elements 22 illustrated in FIG. 2 is arranged in lines from a portion on the left side to a portion on the right side along the X-axis direction over and under the second light guide plate 16. The second light emitting elements 22 are, for example, light-emitting diodes and emit visible light. Note, however, that the second light emitting elements 22 are not limited to light-emitting diodes, and an arbitrary configuration capable of emitting visible light is applicable. Visible light emitted from the second light emitting element 22 is incident on edge surfaces toward the inside of the second light guide plate 16. As described above, the plurality of second light emitting elements 22 constitutes a second light source that emits visible light to be incident on edge surfaces of the second light guide plate 16.

FIG. 2 illustrates, to facilitate understanding, the second light emitting elements 22 over the second light guide plate 16 at positions different from positions of first light emitting elements 21. In practice, when the liquid crystal display device 10 is viewed from the front, the positions of the second light emitting elements 22 may overlap the positions of the first light emitting elements 21. In the light source unit of the liquid crystal display device 10, the plurality of second light emitting elements 22 is only required to be controllable to a current value or a luminous flux value different from that of the plurality of first light emitting elements 21.

The infrared camera 11 illustrated in FIG. 1 is an imaging device capable of generating camera images by sensing infrared light. The infrared light sensed by the infrared camera 11 is output from the infrared light sources 23, is reflected by an object to be imaged, passes through the display unit and the lighting unit of the liquid crystal display device 10, and is subsequently incident on a lens unit and an imaging element of the infrared camera 11. For example, the infrared camera 11 is only required to be an infrared camera that uses electromagnetic waves in a wavelength range of 800 nm or more and 2500 nm or less as infrared light for imaging. To allow infrared light directed at the infrared camera 11 to pass, the rear chassis 12, the reflection sheet 13, and the optical sheet 15 have a through-hole 12H, a through-hole 13H, and a through-hole 15H, respectively. Each of the through-holes 12H, 13H, and 15H serves as an opening that does not block a field of view (FOV) area of the infrared camera 11. The FOV is an imaging range of the camera and is also referred to as a viewing angle or a field angle.

The rear chassis 12 serves as a rear support member that houses and supports and fixes the constituent members, in the rear of the lighting unit and the display unit included in the liquid crystal display device 10. The rear chassis 12 is only required to be shaped in a box with the front side open. The rear chassis 12 is only required to be a rear-side member of a housing that houses the lighting unit and the light source unit included in the liquid crystal display device 10.

The reflection sheet 13 is a sheet member that is capable of reflecting light that has leaked to the rear side from the first light guide plate 14. The reflection sheet 13 may be a mirror surface reflection sheet or a light diffusion reflection sheet. The reflection sheet 13 is only required to be able to be configured using, for example, a resin sheet with a high reflectance such as acrylic resin, a metal thin film sheet such as aluminum sheet and stainless steel sheet, a vapor deposition sheet produced by vapor-depositing aluminum, silver, or the like on a resin film, such as a polyester film, serving as a base sheet, a laminated body of a base sheet made of a resin film and a metal thin film, a diffuser produced by adding light-diffusing particles to a base sheet using a transparent material, a white sheet produced by applying white coating on a film surface, or any other material with a high reflectance.

The first light guide plate 14 is made of a material with a high transmittance for visible light. A material of which the first light guide plate 14 is made is only required to be an acrylic resin such as polymethyl methacrylate (PMMA), a polycarbonate (PC)-based resin, glass, or any other material. The first light guide plate 14 is provided with a dot pattern serving as a light distribution control structure except for one part corresponding to an installation position of the infrared camera 11.

The optical sheet 15 is a sheet member to adjust visible light emitted from the first light guide plate 14 to the front side. The optical sheet 15 is only required to be able to be configured including all or some of a diffusion sheet, a lens sheet, a polarizing sheet, and a louver sheet. The diffusion sheet diffuses the visible light emitted from the first light guide plate 14. The lens sheet adjusts a light distribution direction of light emitted from the first light guide plate 14. The polarizing sheet transmits specific polarized light in the visible light emitted from the first light guide plate 14. The louver sheet removes an unnecessary component of the visible light emitted from the first light guide plate 14.

The second light guide plate 16 is made of a material with a high transmittance for visible light, as with the first light guide plate 14. A material of which the second light guide plate 16 is made is only required to be an acrylic resin such as polymethyl methacrylate (PMMA), a polycarbonate (PC)-based resin, glass, or any other material. The second light guide plate 16 is provided with a dot pattern serving as a light distribution control structure in one part corresponding to the installation position of the infrared camera 11. The second light guide plate 16 is only required to be a plate-shaped light guide member having the same size as that of the first light guide plate 14. Note that as long as the second light guide plate 16 has a size larger than a size of an opening on the front side of the front chassis 17, the second light guide plate 16 may be a plate-shaped light guide member having a size different from that of the first light guide plate 14.

The front chassis 17 serves as a front support member that clamps and thereby supports and fixes the above-described members in conjunction with the rear chassis 12, in front of the lighting unit included in the liquid crystal display device 10. The front chassis 17 is only required to have a frame shape with the rear side open and the front side open except for a peripheral portion. The front chassis 17 is only required to be a front-side member of the housing that houses the lighting unit and the light source unit included in the liquid crystal display device 10.

The liquid crystal panel 18 includes, for example, a thin film transistor (TFT) liquid crystal structure and displays a color image or a monochrome image. For example, the liquid crystal panel 18 includes a pair of a TFT substrate and a counter substrate, a liquid crystal layer in which liquid crystal material is sealingly contained between the above-described substrates, and a pair of polarizing plates. The liquid crystal panel 18 is a transmission-type display panel that performs display, using visible light from the lighting unit of the liquid crystal display device 10. Note that the second light guide plate 16 may be bonded to the liquid crystal panel 18.

In both the first light guide plate 14 and the second light guide plate 16, the dot patterns may be one of protruding portions, recessed portions, steps, protrusions, white paints, and metal thin films, combinations of all or some of the foregoing, or other minute reflecting parts made of an arbitrary structure or member capable of reflecting visible light. The dot patterns are only required to be able to be made by, for example, printing such as inkjet printing, photolithography, etching, laser processing, blasting, or any other physical or chemical manufacturing method. Therefore, the dot patterns may be made inside the first light guide plate 14 and the second light guide plate 16, or may be added to the outside of the first light guide plate 14 and the second light guide plate 16.

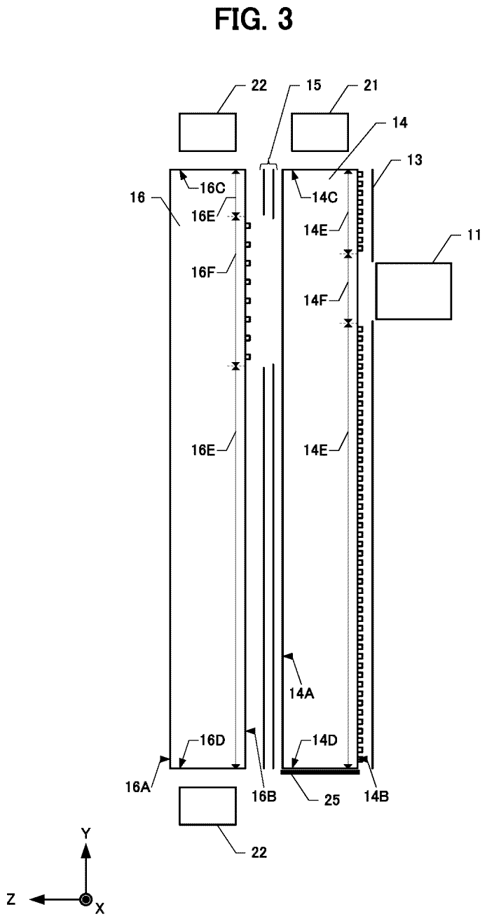

FIG. 3 is a cross-sectional view taken along the line A1-A1 in FIG. 2. In FIG. 3, to describe the lighting unit and the light source unit of the liquid crystal display device 10, illustration of the rear chassis 12, the front chassis 17, and the liquid crystal panel 18 is omitted. The lighting unit of the liquid crystal display device 10 includes the reflection sheet 13, the first light guide plate 14, the optical sheet 15, and the second light guide plate 16 that are arranged on the front side of the infrared camera 11. The light source unit of the liquid crystal display device 10 includes the plurality of first light emitting elements 21 arranged over the first light guide plate 14 and the plurality of second light emitting elements 22 arranged over and under the second light guide plate 16.

The first light guide plate 14 includes a main surface 14A that serves as a light emitting surface emitting visible light in a planar manner on the +Z-direction side that is the front side and a main surface 14B that serves as a light reflecting surface reflecting light on the −Z-direction side that is the rear side. The main surface 14A serves as a first main surface of the first light guide plate 14. The main surface 14B serves as a second main surface on the opposite side to the first main surface of the first light guide plate 14. The first light guide plate 14 includes an edge surface 14C that crosses the main surfaces 14A and 14B on the +Y-direction side that is the upper side and an edge surface 14D that crosses the main surfaces 14A and 14B on the −Y-direction side that is the lower side. The edge surface 14C serves as a first edge surface of the first light guide plate 14. The edge surface 14D serves as a second edge surface on the opposite side to the first edge surface of the first light guide plate 14. It is only required to stick a side surface reflection tape 25 on the edge surface 14D.

The first light guide plate 14 illustrated in FIG. 3 is provided with a dot pattern serving as a light distribution control structure provided in a first area 14E of the main surface 14B. The first area 14E of the main surface 14B is only required to serve as a first reflection area that reflects visible light propagating inside the first light guide plate 14 to the main surface 14A side, that is, the +Z-direction side that is the front side. The first area 14E of the main surface 14B is an area remaining after the portion corresponding to the installation position of the infrared camera 11 is excepted from the main surface 14B of the first light guide plate 14. In other words, the first area 14E of the main surface 14B is an area corresponding to a range where the infrared camera 11 is not installed, on the main surface 14B of the first light guide plate 14.

The first light guide plate 14 is not provided with a dot pattern in a second area 14F of the main surface 14B. The second area 14F of the main surface 14B is an area in which the portion corresponding to the installation position of the infrared camera 11 is included, on the main surface 14B of the first light guide plate 14. In other words, the second area 14F of the main surface 14B is an area corresponding to the range where the infrared camera 11 is installed, on the main surface 14B of the first light guide plate 14. The second area 14F of the main surface 14B has a size that is determined in accordance with the FOV of the infrared camera 11.

In the +Y-direction that is the upward direction of the first light guide plate 14 illustrated in FIG. 3, the plurality of first light emitting elements 21 is arranged. Visible light emitted from the first light emitting elements 21 propagates in the −Y-direction that is the downward direction and is incident on the edge surface 14C of the first light guide plate 14 into the inside of the first light guide plate 14. The visible light having been incident on the edge surface 14C of the first light guide plate 14 propagates inside the first light guide plate 14 while repeating total reflection from the +Y-direction side that is the upper side to the −Y-direction side that is the lower side. On this occasion, all or a portion of visible light that has spread to the +Z-direction side that is the front side may undergo total reflection at the main surface 14A of the first light guide plate 14. A portion of visible light that has spread to the −Z-direction side that is the rear side may undergo total reflection at the main surface 14B of the first light guide plate 14, and another portion may be reflected or scattered by the dot pattern provided in the first area 14E of the main surface 14B. The dot pattern provided in the first area 14E of the main surface 14B is only required to be capable of controlling light distribution direction through reflection or scattering of visible light. In the first light guide plate 14, visible light that has reached the edge surface 14D is reflected by the side surface reflection tape 25.

The dot pattern provided in the first area 14E on the main surface 14B of the first light guide plate 14 may have, for example, a pattern occupancy rate of approximately 20 to 80%. The pattern occupancy rate is a ratio of total area of an area used for shaping the dot pattern per unit area. The pattern occupancy rate of the dot pattern is only required to correspond to size and the number or density of dots of the dot pattern.

In the first light guide plate 14 illustrated in FIG. 3, visible light reflected to the +Z-direction side that is the front side by the dot pattern provided in the first area 14E of the main surface 14B is emitted from the main surface 14A of the first light guide plate 14 to the +Z-direction side that is the front side. Visible light that is scattered to the −Z-direction side that is the rear side by the dot pattern provided in the first area 14E of the main surface 14B is reflected by the reflection sheet 13, returns to the first light guide plate 14, and is emitted from the main surface 14A of the first light guide plate 14 to the +Z-direction side that is the front side. Therefore, in the first light guide plate 14, the visible light incident on the edge surface 14C into the inside is emitted from a range of the main surface 14A corresponding to the first area 14E where the dot pattern is provided. In contrast, the first light guide plate 14 is unable to emit or involves difficulty in emitting visible light from a range of the main surface 14A corresponding to the second area 14F where no dot pattern is provided. The dot pattern provided in the first area 14E on the main surface 14B of the first light guide plate 14 is only required to have the pattern occupancy rate or the like adjusted in such a way that visible light emitted from the main surface 14A to the +Z-direction side that is the front side has a uniform or arbitrary distribution.

The second light guide plate 16 includes a main surface 16A that serves as a light emitting surface emitting visible light in a planar manner on the +Z-direction side that is the front side and a main surface 16B on which visible light from the first light guide plate 14 or the optical sheet 15 is incident on the −Z-direction side that is the rear side. The main surface 16A serves as a first main surface of the second light guide plate 16. The main surface 16B serves as a second main surface on the opposite side to the first main surface of the second light guide plate 16. The second light guide plate 16 includes an edge surface 16C that crosses the main surfaces 16A and 16B on the +Y-direction side that is the upper side and an edge surface 16D that crosses the main surfaces 16A and 16B on the −Y-direction side that is the lower side. The edge surface 16C serves as a first edge surface of the second light guide plate 16. The edge surface 16D serves as a second edge surface on the opposite side to the first edge surface of the second light guide plate 16.

The second light guide plate 16 illustrated in FIG. 3 is arranged in such a manner as to overlap the first light guide plate 14 in a direction perpendicular to the main surface 14A of the first light guide plate 14. That is, the second light guide plate 16 is stacked over the first light guide plate 14 along the Z-axis direction. Note that the optical sheet 15 is interposed and stacked between the first light guide plate 14 and the second light guide plate 16. The second light guide plate 16 is not provided with a dot pattern serving as a light distribution control structure in the first area 16E of the main surface 16B. The first area 16E of the main surface 16B is an area remaining after one part corresponding to the installation position of the infrared camera 11 is excepted from the main surface 16B of the second light guide plate 16. In other words, the first area 16E of the main surface 16B is an area corresponding to a range where the infrared camera 11 is not installed, on the main surface 16B of the second light guide plate 16.

The second light guide plate 16 is provided with a dot pattern in a second area 16F of the main surface 16B. The second area 16F of the main surface 16B is only required to serve as a second reflection area that reflects visible light propagating inside the second light guide plate 16 to the main surface 16A side, that is, the +Z-direction side that is the front side. The second area 16F of the main surface 16B is an area in which one part corresponding to the installation position of the infrared camera 11 is included, on the main surface 16B of the second light guide plate 16. In other words, the second area 16F of the main surface 16B is an area corresponding to the range where the infrared camera 11 is installed, on the main surface 16B of the second light guide plate 16. The second area 16F of the main surface 16B has a size that is determined in accordance with the FOV of the infrared camera 11.

In the +Y-direction that is the upward direction and the −Y-direction that is the downward direction of the second light guide plate 16 illustrated in FIG. 3, the plurality of second light emitting elements 22 is arranged. Visible light emitted from the second light emitting elements 22 is incident on the edge surfaces 16C and 16D of the second light guide plate 16 into the inside of the second light guide plate 16. For example, the visible light emitted from the second light emitting elements 22 arranged in the +Y-direction that is the upward direction of the second light guide plate 16 propagates in the −Y-direction that is the downward direction and is incident on the edge surface 16C of the second light guide plate 16 into the inside of the second light guide plate 16. The visible light emitted from the second light emitting elements 22 arranged in the −Y-direction that is the downward direction of the second light guide plate 16 propagates in the +Y-direction that is the upward direction and is incident on the edge surface 16D of the second light guide plate 16 into the inside of the second light guide plate 16. The visible light incident on the edge surfaces 16C and 16D of the second light guide plate 16 propagates inside the second light guide plate 16 while repeating total reflection and reaches the second area 16F of the main surface 16B where the dot pattern is provided. The dot pattern provided in the second area 16F of the main surface 16B is only required to be capable of controlling light distribution direction through reflection or scattering of visible light.

The dot pattern provided in the second area 16F on the main surface 16B of the second light guide plate 16 may have, for example, a pattern occupancy rate of approximately 20%. The dot pattern provided in the second area 16F on the main surface 16B of the second light guide plate 16 is only required to have a distribution of dots where the pattern occupancy rate is uniform or a distribution of dots where the pattern occupancy rate varies in such a way that brightness uniformity of visible light emitted from the main surface 16A of the second light guide plate 16 to the front side is improved. In addition, the dot pattern provided in the second area 16F of the main surface 16B is only required to be a dot pattern the pattern occupancy rate of which is determined in such a way as not to influence visibility of camera images generated by the infrared camera 11. The dot pattern provided in the second area 16F of the main surface 16B may have a different pattern occupancy rate from the dot pattern provided in the first area 14E of the main surface 14B in the first light guide plate 14.

In the second light guide plate 16 illustrated in FIG. 3, visible light reflected to the +Z-direction side that is the front side by the dot pattern provided in the second area 16F of the main surface 16B is emitted from the main surface 16A of the second light guide plate 16 to the +Z-direction side that is the front side. Therefore, in the second light guide plate 16, the visible light incident on the edge surfaces 16C and 16D into the inside is emitted from a range of the main surface 16A corresponding to the second area 16F where the dot pattern is provided. In contrast, in the second light guide plate 16, a range of the main surface 16A corresponding to the first area 16E where no dot pattern is provided emits visible light that is emitted from the main surface 14A of the first light guide plate 14, transmitted through the optical sheet 15, and subsequently incident on the main surface 16B of the second light guide plate 16.

In the second light guide plate 16, a range of the main surface 16A that emits visible light emitted from the main surface 14A of the first light guide plate 14 and incident on the main surface 16B of the second light guide plate 16 is only required to serve as a first emitting area of the light emitting surface in the lighting unit of the liquid crystal display device 10. In the second light guide plate 16, a range of the main surface 16A where visible light incident on the edge surfaces 16C and 16D into the inside is reflected or scattered by the dot pattern provided in the second area 16F of the main surface 16B and is emitted is only required to serve as a second emitting area of the light emitting surface in the lighting unit of the liquid crystal display device 10. The above-described first emitting area and second emitting area do not have to be clearly separated ranges. The first emitting area and the second emitting area may include an overlapping range where beams of visible light emitted from both areas are mixed. Therefore, the second emitting area of the light emitting surface in the lighting unit of the liquid crystal display device 10 is only required to be different from the first emitting area of the light emitting surface at least in part. The dot pattern provided in the first area 14E of the first light guide plate 14 and the dot pattern provided in the second area 16F of the second light guide plate 16 can be adjusted with respect to an arbitrary characteristic, such as a shape, size, density, a pattern occupancy rate, and composition materials, and are only required to be able to achieve the brightness uniformity of visible light emitted from the lighting unit of the liquid crystal display device 10. The characteristics of the dot pattern provided in the first area 14E of the first light guide plate 14 may be adjustable by taking into consideration the arrangement of the plurality of first light emitting elements 21 included in the first light source. The characteristics of the dot pattern provided in the second area 16F of the second light guide plate 16 may be adjustable by taking into consideration the arrangement of the plurality of second light emitting elements 22 included in the second light source. Each dot pattern preferably has a shape that causes visible light to be reflected or scattered at an angle close to the vertical direction with respect to the light emitting surface of the lighting unit in the liquid crystal display device 10. The plurality of second light emitting elements 22 that constitutes the second light source is only required to be controllable to a current value or a luminous flux value that is different from that of the plurality of first light emitting elements 21 that constitutes the first light source and thereby be able to achieve the brightness uniformity of the visible light emitted from the lighting unit of the liquid crystal display device 10.

The first light guide plate 14 may be included in a first lighting that provides the liquid crystal panel 18 with visible light emitted from a range serving as a first area of the light emitting surface and corresponding to the first area 14E of the main surface 14B, in the lighting unit of the liquid crystal display device 10. The second light guide plate 16 may be included in a second lighting that provides the liquid crystal panel 18 with visible light emitted from a range serving as a second area at least a portion of which is different from the first area of the light emitting surface and corresponding to the second area 16F of the main surface 16B, in the lighting unit of the liquid crystal display device 10.

In the second light guide plate 16, infrared light incident from +Z-direction side that is the front side of the main surface 16A can propagate inside the second light guide plate 16 to the −Z-direction side that is the rear side. Subsequently, at least a portion of the infrared light can be transmitted through the second area 16F of the main surface 16B. In the first light guide plate 14, infrared light incident from the +Z-direction side that is the front side of the main surface 14A can propagate inside the first light guide plate 14 to the −Z-direction side that is the rear side. Subsequently, at least a portion of the infrared light can be transmitted through the second area 14F of the main surface 14B. The infrared light transmitted through the first light guide plate 14 and the second light guide plate 16 as described above is only required to be able to pass through the through-hole 15H serving as an opening provided in the optical sheet 15, the through-hole 13H serving as an opening provided in the reflection sheet 13, and the through-hole 12H serving as an opening provided in the rear chassis 12, and be incident on the infrared camera 11. Note that the liquid crystal panel 18 is only required to allow infrared light to be transmitted through the liquid crystal layer and the like.

The infrared camera 11 is capable of generating camera images by sensing infrared light. The infrared light to be sensed by the infrared camera 11 is transmitted through the lighting unit of the liquid crystal display device 10, and is subsequently incident on the lens unit and the imaging element of the infrared camera 11. Therefore, the infrared camera 11 is only required to be capable of performing imaging, using infrared light that is transmitted through the second area 16F that serves as one partial area of the main surface 16B and where a dot pattern is provided, in the second light guide plate 16. The second light guide plate 16 is only required to be able to transmit infrared light used for imaging by the infrared camera 11 through the second area 16F that serves as the one partial area of the main surface 16B and where the dot pattern is provided.

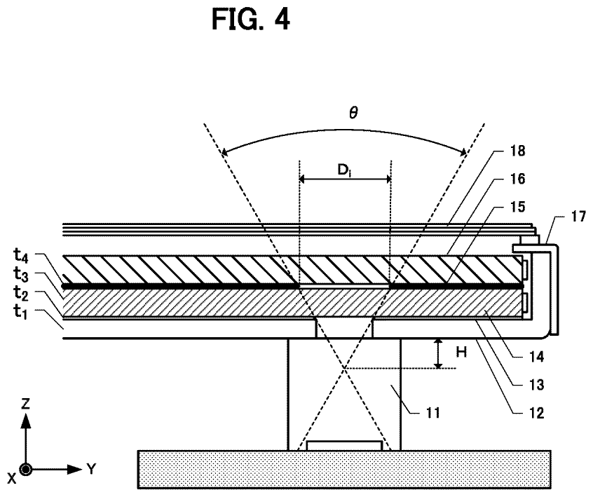

FIG. 4 is a cross-sectional view illustrating diameter Dᵢ of a through-hole made as an opening in each member. Hereinbelow, distance from a focal position of the lens in the infrared camera 11 to a mounting surface for the infrared camera 11 on the rear chassis 12 is denoted by H. Thickness of each member is denoted by tₖ. The integer k indicates the number of members from the mounting surface for the infrared camera 11 to a member to be numbered, and, for example, it is only required that “1”, “2”, “3”, and “4” be set for the rear chassis 12, the reflection sheet 13, the first light guide plate 14, and the optical sheet 15, respectively. In addition, an angle corresponding to the FOV of the infrared camera 11 is denoted by θ. In this case, the diameter Dᵢ of the through-hole made in the i-th member is only required to be determined by the following mathematical formula. Note that the diameter Dᵢ of a through-hole may be determined by taking into consideration a refractive index nₖ of a member through which infrared light is transmitted.

$$[ Math 1 ]$$

$${D}_{i} = 2 \times tan \frac{θ}{2} \times ( H + {\sum }_{k = 1}^{i} {t}_{k} )$$

In the lighting unit of the liquid crystal display device 10 illustrated in FIG. 3, the first light guide plate 14 is arranged on the front side of the reflection sheet 13. The optical sheet 15 is arranged on the front side of the first light guide plate 14. The second light guide plate 16 is arranged on the front side of the optical sheet 15. Therefore, the diameter of the through-hole 15H made as an opening of the optical sheet 15 has a size greater than or equal to the diameter of the second area 14F where no dot pattern is provided on the main surface 14B of the first light guide plate 14. The diameter of the second area 14F where no dot pattern is provided on the main surface 14B of the first light guide plate 14 has a size greater than or equal to the diameter of the through-hole 13H that is made as an opening of the reflection sheet 13. In addition, the diameter of the second area 16F where a dot pattern is provided on the main surface 16B of the second light guide plate 16 has a size greater than or equal to the diameter of the through-hole 15H that is made as an opening of the optical sheet 15.

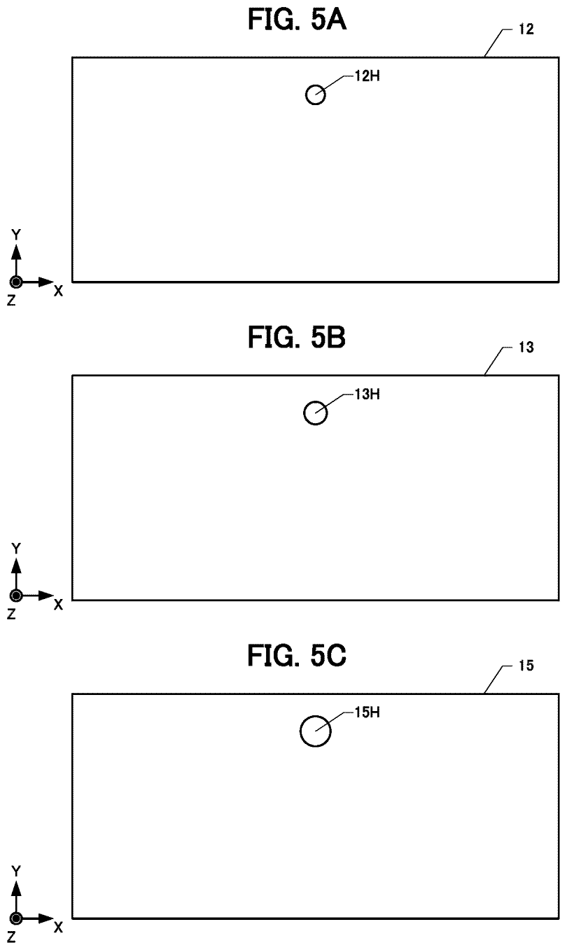

FIGS. 5A to 5E are front views illustrating configuration examples of the members included in the lighting unit of the liquid crystal display device 10. Among the drawings, FIG. 5A is a front view illustrating a configuration example of the rear chassis 12. FIG. 5B is a front view illustrating a configuration example of the reflection sheet 13. FIG. 5C is a front view illustrating a configuration example of the optical sheet 15. FIG. 5D is a front view illustrating a configuration example of the first light guide plate 14. FIG. 5E is a front view illustrating a configuration example of the second light guide plate 16.

The rear chassis 12 illustrated in FIG. 5A has the through-hole 12H as an opening through which infrared light can pass. The diameter of the through-hole 12H is only required to be determinable by the afore-described mathematical formula, using the FOV of the infrared camera 11, the distance from the focal position of the lens in the infrared camera 11 to the mounting surface for the infrared camera 11 on the rear chassis 12, and the thickness of the rear chassis 12.

The reflection sheet 13 illustrated in FIG. 5B has the through-hole 13H as an opening through which infrared light can pass. The diameter of the through-hole 13H has a size greater than or equal to the diameter of the through-hole 12H in the rear chassis 12. The diameter of the through-hole 13H is only required to be determinable by the afore-described mathematical formula, using the thickness of the reflection sheet 13, as well as the factors used when the diameter of the through-hole 12H in the rear chassis 12 is determined.

The optical sheet 15 illustrated in FIG. 5C has the through-hole 15H as an opening through which infrared light can pass. The diameter of the through-hole 15H has a size greater than or equal to the diameter of the second area 14F where no dot pattern is provided on the main surface 14B of the first light guide plate 14. The diameter of the through-hole 15H is only required to be determinable by the afore-described mathematical formula, using the thickness of the first light guide plate 14 and the thickness of the optical sheet 15, as well as the factors used when the diameter of the through-hole 13H in the reflection sheet 13 is determined. In addition, the diameter of the through-hole 15H may be determined by taking into consideration the refractive index of the first light guide plate 14 through which infrared light is transmitted.

The first light guide plate 14 illustrated in FIG. 5D includes the first area 14E and the second area 14F provided on the main surface 14B. The first area 14E is provided with a dot pattern. The dot pattern provided in the first area 14E is only required to be an example of a first light distribution control structure that reflects or scatters visible light incident on the edge surface 14C from the plurality of first light emitting elements 21 included in the first light source. The second area 14F is not provided with a dot pattern. The second area 14F is only required to be an example of a first infrared light transmitting portion through which most infrared light can be transmitted without being reflected. The diameter of the second area 14F has a size greater than or equal to the diameter of the through-hole 13H in the reflection sheet 13. In the first area 14E different from the second area 14F, the dot pattern is provided on the main surface 14B that is located on the rear side and that is adjacent to the reflection sheet 13, on the first light guide plate 14. Therefore, the diameter of the second area 14F is only required to be determinable by the afore-described mathematical formula, using the same factors as the factors used when the diameter of the through-hole 13H in the reflection sheet 13 is determined. The first light guide plate 14 is provided with a dot pattern serving as the first light distribution control structure in the first area 14E that is a remaining area with the exception of the second area 14F as one partial area of the main surface 14B.

The second light guide plate 16 illustrated in FIG. 5E includes the first area 16E and the second area 16F provided on the main surface 16B. The first area 16E is not provided with a dot pattern. The second area 16F is provided with a dot pattern. The dot pattern provided in the second area 16F is only required to be an example of a second light distribution control structure that reflects or scatters visible light incident on the edge surfaces 16C and 16D from the plurality of second light emitting elements 22 included in the second light source. The second area 16F is only required to be an example of a second infrared light transmitting portion through which at least a portion of infrared light can be transmitted without being reflected. The diameter of the second area 16F has a size greater than or equal to the diameter of the through-hole 15H in the optical sheet 15. In the second area 16F, the dot pattern is provided on the main surface 16B that is located on the −Z-direction side, the −Z-direction side being the rear side, and that is adjacent to the optical sheet 15, on the second light guide plate 16. Therefore, the diameter of the second area 16F is only required to be determinable by the afore-described mathematical formula, using the same factors as the factors used when the diameter of the through-hole 15H in the optical sheet 15 is determined. The second light guide plate 16 is provided with a dot pattern serving as the second light distribution control structure in the second area 16F as one partial area of the main surface 16B.

Note that the FOV of the infrared camera 11 is not limited to a circular shape and may also be a rectangular shape, such as a square and rectangle, or any other shape including other polygons. It is only required that regardless of the shape of the FOV, the positions and sizes of the through-holes 12H, 13H, and 15H, the positions and sizes of the second area 14F on the main surface 14B of the first light guide plate 14 and the second area 16F on the main surface 16B of the second light guide plate 16 be able to be determined in such a way as not to block the FOV area of the infrared camera 11 and to secure visibility of the camera images. Therefore, the through-holes 12H, 13H, and 15H serving as openings are arranged in accordance with the FOV of the infrared camera 11 and have sizes matching the FOV of the infrared camera 11. The second area 14F on the main surface 14B of the first light guide plate 14 and the second area 16F on the main surface 16B of the second light guide plate 16 are arranged in accordance with the FOV of the infrared camera 11 and have sizes matching the FOV of the infrared camera 11.

In recent years, self-driving vehicles that are vehicles equipped with safety technology for autonomous driving have been widely put on sale. Technology guidelines for self-driving vehicles require a human-machine interface that includes a function to monitor, for example, a state of a driver of a vehicle. This technology is stipulated as essential for Level 3 and Level 4 self-driving vehicles and is also applied to a Level 2 vehicle. The function to monitor the state of the driver of a vehicle enables whether or not the driver is in a state in which the driver can take over driving operation from the self-driving system to be determined. In addition, this function is required to sense a danger about which an alarm has to be raised. To achieve such a function, a technology for imaging the state of a driver of a vehicle, such as whether or not the driver of the vehicle is dozing off, by a camera is required. The camera used for the imaging can be incorporated into, for example, a steering column, a center console, or a portion of a liquid crystal display meter. When a camera is incorporated into the liquid crystal display meter, a portion where the camera is installed becomes a notch and it becomes difficult to display an image on the notch. Alternatively, a problem arises in that since an area where the camera is installed cannot be provided with a pattern for light emission or the like, the area becomes dark compared with surroundings of the area.

In the liquid crystal display device 10, it is necessary to cause the optical sheet 15 to have the through-hole 15H serving as an opening, to secure visibility of camera images generated by the infrared camera 11. The lighting unit of the liquid crystal display device 10 comes to have a less amount of visible light emitted in a direction perpendicular to the display surface of the liquid crystal panel 18 in a range corresponding to the through-hole 15H than in a range other than the through-hole 15H, and, as a result, brightness is reduced. When a dot pattern is provided in the second area 14F corresponding to the installation position of the infrared camera 11 on the main surface 14B of the first light guide plate 14 without the second light guide plate 16, the brightness decreases in the range of the second area 14F. Therefore, the lighting unit of the liquid crystal display device 10 cannot achieve brightness uniformity.

In the liquid crystal display device 10 of the present disclosure, the lighting unit includes the second light guide plate 16. In addition, in the liquid crystal display device 10 of the present disclosure, the light source unit includes the plurality of second light emitting elements 22 as the second light source that emits visible light to be incident on the edge surfaces 16C and 16D of the second light guide plate 16. The plurality of second light emitting elements 22 constituting the second light source is provided separately from the plurality of first light emitting elements 21 constituting the first light source. The plurality of first light emitting elements 21 constituting the first light source emits visible light to be incident on the edge surface 14C of the first light guide plate 14. The current value of the second light emitting elements 22 can be controlled in a different manner from the current value of the first light emitting element 21. The main surface 14A of the first light guide plate 14 is capable of emitting reflected light from the dot pattern and the like to the +Z-direction side that is the front side within the range of the first area 14E that is different from the installation position of the infrared camera 11. The main surface 16A of the second light guide plate 16 is capable of emitting reflected light from the dot pattern and the like to the +Z-direction side that is the front side within the range of the second area 16F corresponding to the installation position of the infrared camera 11. In this case, the visible light emitted from the range of the second area 16F can be set to have the same brightness as the brightness of the visible light emitted from the range of the first area 14E. Therefore, the liquid crystal display device 10 of the present disclosure is capable of making the brightness of the visible light emitted from the lighting unit uniform. In addition, the dot pattern provided in the second area 16F on the main surface 16B of the second light guide plate 16 has a pattern occupancy rate that allows at least a portion of infrared light having propagated inside the second light guide plate 16 to be transmitted. Because of this configuration, the visibility of camera images generated by infrared camera 11 can be secured.

In Embodiment 1, the second light guide plate 16 overlaps the first light guide plate 14 in a direction of the main surface 14A that is a direction perpendicular to a main surface of the first light guide plate 14, that is, the Z-axis direction. The first light source including the plurality of first light emitting elements 21 emits visible light to be incident on the edge surface 14C of the first light guide plate 14. The second light source including the plurality of second light emitting elements 22 emits visible light to be incident on the edge surfaces 16C and 16D of the second light guide plate 16. The first light guide plate 14 is provided with a dot pattern in the first area 14E that is a remaining area with the exception of the second area 14F as one partial area of the main surface 14B. The dot pattern provided in the first area 14E is only required to be an example of the first light distribution control structure that reflects or scatters visible light incident on the edge surface 14C of the first light guide plate 14 from the first light source. The second light guide plate 16 is provided with a dot pattern in the second area 16F that is one partial area of the main surface 16B. The dot pattern provided in the second area 16F is only required to be an example of the second light distribution control structure that reflects or scatters visible light incident on the edge surfaces 16C and 16D of the second light guide plate 16 from the second light source. The second area 16F where the dot pattern is provided is capable of transmitting at least a portion of the infrared light having propagated inside the second light guide plate 16. Because of this configuration, when the infrared camera 11 is arranged, a suitable display can be achieved.

In the first light guide plate 14, a range of the main surface 14A corresponding to the first area 14E of the main surface 14B and emitting visible light to the +Z-direction side that is the front side serves as a first light emitting area that is a main surface portion where the infrared camera 11 is not installed. In the second light guide plate 16, a range of the main surface 16A corresponding to the second area 16F of the main surface 16B and emitting visible light to the +Z-direction side that is the front side serves as a second light emitting area that is a main surface portion where the infrared camera 11 is installed. As described above, the first light guide plate 14 includes the first light emitting area that causes visible light to be emitted from the main surface portion where the infrared camera 11 is not installed. The second light guide plate 16 includes the second light emitting area that causes visible light to be emitted from the main surface portion where the infrared camera 11 is installed.

The plurality of first light emitting elements 21 constitutes the first light source that radiates visible light toward the edge surface 14C of the first light guide plate 14. The plurality of second light emitting elements 22 constitutes the second light source that radiates visible light toward the edge surfaces 16C and 16D of the second light guide plate 16. The first light guide plate 14 distributes visible light incident from the first light source toward a range serving as the first light emitting area of the main surface 14A by reflecting or scattering the visible light at the dot pattern provided in the first area 14E of the main surface 14B. The second light guide plate 16 distributes visible light incident from the second light source toward a range serving as the second light emitting area of the main surface 16A by reflecting or scattering the visible light at the dot pattern provided in the second area 16F of the main surface 16B. As described above, the main surface 14B of the first light guide plate 14 includes the first area 14E that serves as a first light distribution control area that distributes the visible light incident from the first light source toward the first light emitting area. The main surface 16B of the second light guide plate 16 includes the second area 16F that serves as a second light distribution control area that distributes the visible light incident from the second light source toward the second light emitting area.

The infrared camera 11 does not have sensitivity in a visible light region or has a considerably low sensitivity in the visible light region compared with sensitivity in an infrared region. Because of this characteristic, the infrared camera 11 of the liquid crystal display device 10 is capable of performing imaging even while the lighting unit is emitting visible light, and thereby enables the visibility of camera images to be secured. In contrast, when imaging using a visible light camera is performed, change in an operation mode in which the lighting unit of the liquid crystal display device 10 is temporarily and partially switched from a turned-on state to a turned-off state becomes necessary. As described above, the lighting unit of the liquid crystal display device 10 is, differing from a case where a visible light camera is used, capable of performing imaging using the infrared camera 11 without switching the operation modes corresponding to the turned-on state and the turned-off state, and generating appropriate camera images. Therefore, the lighting unit that the liquid crystal display device 10 of the present disclosure includes is capable of achieving appropriate imaging and display while reducing the burden of controlling switching of operations, compared with the case where a visible light camera is used.

The second light guide plate 16 is capable of reflecting or scattering visible light by the dot pattern provided in the second area 16F of the main surface 16B and emitting the visible light to the +Z direction side that is the front side from the area of the main surface 16A that corresponds to the range where the infrared camera 11 is installed. In addition, the plurality of second light emitting elements 22 constituting the second light source can be controlled to a current value or a luminous flux value that is different from that of the plurality of first light emitting elements 21 constituting the first light source. Therefore, even in the range where the infrared camera 11 is installed, it becomes possible to emit visible light having a sufficient light amount and achieve uniform brightness across the entire light emitting surface including a center portion of the range where the infrared camera 11 is installed.

The second light guide plate 16 is only required to be a plate-shaped light guide member that has approximately the same size as the first light guide plate 14, and overlaps the first light guide plate 14 in the direction of the main surface 14A that is a direction perpendicular to a main surface of the first light guide plate 14. Meanwhile, there is a liquid crystal display device where in a configuration in which a light guide plate for display and a light guide plate for camera are arranged side-by-side with edge surfaces thereof joined, light shielding material is used at a boundary between the light guide plates. In this case, in the liquid crystal display device, a linear boundary is visually recognized at the joint portion of the light guide plates. The liquid crystal display device 10 of the present disclosure is capable of preventing a linear boundary from being visually recognized at the joint portion of a plurality of light guide plates, and achieving appropriate imaging and display.

The area from which visible light is emitted by the second light guide plate 16 is only required to have a size that allows the FOV of the infrared camera 11 to be secured. Since the plurality of second light emitting elements 22 that serves as the second light source causing visible light to be incident on the second light guide plate 16 is arranged on the outer side of the edge surfaces 16C and 16D of the second light guide plate 16, it is not required to install a light source device in surroundings of the infrared camera 11. Because of this configuration, it is possible to secure a suitable light source with only a minor disadvantage that thickness of the second light guide plate 16 increases, and achieve appropriate imaging and display.

### Embodiment 2

In a light source unit of a liquid crystal display device 10, a plurality of second light emitting elements 22 included in a second light source is only required to be installed in an arbitrary arrangement that enables visible light propagating to a second area 16F where a dot pattern is provided on a main surface 16B of a second light guide plate 16 to be supplied.

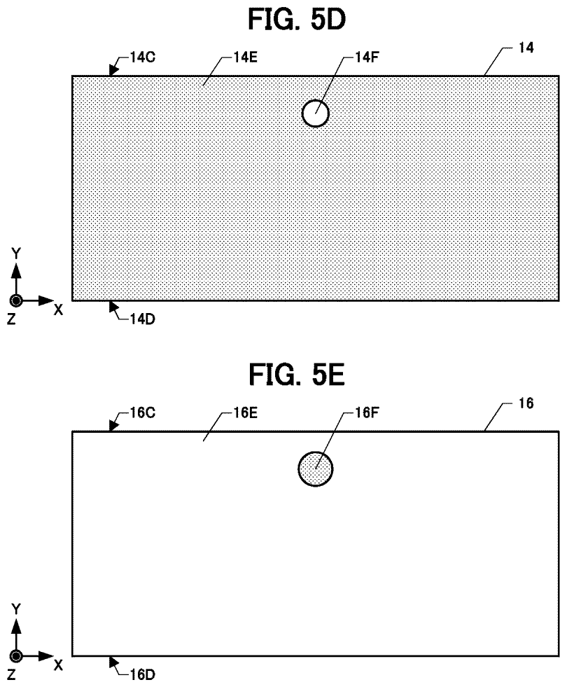

FIGS. 6A to 6F are front views illustrating arrangement examples of the plurality of second light emitting elements 22 in Embodiment 2 that are different from the arrangement in Embodiment 1. Among the drawings, FIG. 6A illustrates an arrangement example in which the plurality of second light emitting elements 22 is provided only on the −Y-direction side that is the lower side of the second light guide plate 16. FIG. 6B illustrates an arrangement example in which the plurality of second light emitting elements 22 is provided only on the +Y-direction side that is the upper side of the second light guide plate 16. FIG. 6C illustrates an arrangement example in which the plurality of second light emitting elements 22 is provided from the left end to the right end on the +Y-direction side that is the upper side and the −Y-direction side that is the lower side of the second light guide plate 16. FIG. 6D illustrates an arrangement example in which the plurality of second light emitting elements 22 is provided only on the −X-direction side that is the left side of the second light guide plate 16. FIG. 6E illustrates an arrangement example in which the plurality of second light emitting elements 22 is provided only on the +X-direction side that is the right side of the second light guide plate 16. FIG. 6F illustrates an arrangement example in which the plurality of second light emitting elements 22 is provided from a portion on the left side to a portion on the right side on the −X-direction side that is the left side and the +X-direction side that is the right side of the second light guide plate 16.

The second light guide plate 16 includes, in addition to main surfaces 16A and 16B and edge surfaces 16C and 16D, an edge surface 16G that crosses the main surfaces 16A and 16B on the −X-direction side that is the left side and an edge surface 16H that crosses the main surfaces 16A and 16B on the +X-direction side that is the right side.

In the arrangement example illustrated in FIG. 6A, visible light emitted from the second light source in which the plurality of second light emitting elements 22 is included is incident on the edge surface 16D located in the −Y-direction that is the downward direction of the second light guide plate 16 into the inside of the second light guide plate 16. The visible light incident on the edge surface 16D of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from a range of the main surface 16A corresponding to the second area 16F, an area corresponding to a range where the infrared camera 11 is installed can be illuminated. Note that the plurality of second light emitting elements 22 may be arranged in a line along the X-axis direction from the left end to the right end of the edge surface 16D on the −Y-direction side that is the lower side of the second light guide plate 16.

In the arrangement example illustrated in FIG. 6B, visible light emitted from the second light source in which the plurality of second light emitting elements 22 is included is incident on the edge surface 16C located in the +Y-direction that is the upward direction of the second light guide plate 16 into the inside of the second light guide plate 16. The visible light incident on the edge surface 16C of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from the range of the main surface 16A corresponding to the second area 16F, the area corresponding to the range where the infrared camera 11 is installed can be illuminated. Note that the plurality of second light emitting elements 22 may be arranged in a line along the X-axis direction from the left end to the right end of the edge surface 16C on the +Y-direction side that is the upper side of the second light guide plate 16.

In the arrangement example illustrated in FIG. 6C, visible light emitted from the second light source in which the plurality of second light emitting elements 22 is included is incident on the edge surface 16C located in the +Y-direction that is the upward direction of the second light guide plate 16 and the edge surface 16D located in the −Y-direction that is the downward direction of the second light guide plate 16 into the inside of the second light guide plate 16. The visible light incident on the edge surfaces 16C and 16D of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from the range of the main surface 16A corresponding to the second area 16F, the area corresponding to the range where the infrared camera 11 is installed can be illuminated. As described above, the plurality of second light emitting elements 22 may be arranged in a line along the X-axis direction from the left end to the right end of the edge surface 16D on the −Y-direction side that is the lower side of the second light guide plate 16 and also arranged in a line along the X-axis direction from the left end to the right end of the edge surface 16C on the +Y-direction side that is the upper side of the second light guide plate 16.

In the arrangement example illustrated in FIG. 6D, visible light emitted from the second light source in which the plurality of second light emitting elements 22 is included is incident on the edge surface 16G located in the −X-direction that is the leftward direction of the second light guide plate 16 into the inside of the second light guide plate 16. The visible light incident on the edge surface 16G of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from the range of the main surface 16A corresponding to the second area 16F, the area corresponding to the range where the infrared camera 11 is installed can be illuminated. Note that the plurality of second light emitting elements 22 may be arranged in a line along the Y-axis direction from the upper end to the lower end of the edge surface 16G on the −X-direction side that is the left side of the second light guide plate 16.

In the arrangement example illustrated in FIG. 6E, visible light emitted from the second light source in which the plurality of second light emitting elements 22 is included is incident on the edge surface 16H located in the +X-direction that is the rightward direction of the second light guide plate 16 into the inside of the second light guide plate 16. The visible light incident on the edge surface 16H of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from the range of the main surface 16A corresponding to the second area 16F, the area corresponding to the range where the infrared camera 11 is installed can be illuminated. Note that the plurality of second light emitting elements 22 may be arranged in a line along the Y-axis direction from the upper end to the lower end of the edge surface 16H on the +X-direction side that is the right side of the second light guide plate 16.

In the arrangement example illustrated in FIG. 6F, visible light emitted from the second light source in which the plurality of second light emitting elements 22 is included is incident on the edge surface 16G located in the −X-direction that is the leftward direction of the second light guide plate 16 and the edge surface 16H located in the +X-direction that is the rightward direction of the second light guide plate 16 into the inside of the second light guide plate 16. The visible light incident on the edge surfaces 16G and 16H of the second light guide plate 16 propagates inside the second light guide plate 16 and is subsequently, due to reaching the dot pattern provided in the second area 16F of the main surface 16B, reflected or scattered. Since because of this configuration, the visible light incident on the second light guide plate 16 is emitted to the +Z-direction side that is the front side from the range of the main surface 16A corresponding to the second area 16F, the area corresponding to the range where the infrared camera 11 is installed can be illuminated. Note that the plurality of second light emitting elements 22 may be arranged in a line along the Y-axis direction from the upper end to the lower end of the edge surface 16G on the −X-direction side that is the left side of the second light guide plate 16 and also arranged in a line along the Y-axis direction from the upper end to the lower end of the edge surface 16H on the +X-direction side that is the right side of the second light guide plate 16.

As described above, the plurality of second light emitting elements 22 included in the second light source is only required to be light emitting elements installed in an arbitrarily arrangement that enables the area of the second light guide plate 16 corresponding to the range where the infrared camera 11 is installed to be illuminated. When the FOV of the infrared camera 11 is sufficiently small, the second light source may be able to be configured including one second light emitting element 22. Therefore, the second light source is only required to be a light source including at least one second light emitting element 22. A plurality of first light emitting elements 21 included in a first light source is only required to be light emitting elements installed in an arbitrarily arrangement that enables an area of a first light guide plate 14 corresponding to a range where the infrared camera 11 is not installed to be illuminated.

In Embodiment 2, the second light guide plate 16 also overlaps the first light guide plate 14 in a direction of a main surface 14A that is a direction perpendicular to a main surface of the first light guide plate 14, that is, the Z-axis direction. The first light source including the plurality of first light emitting elements 21 emits visible light to be incident on an edge surface 14C of the first light guide plate 14. The second light source including the plurality of second light emitting elements 22 emits visible light to be incident on one or both of the edge surfaces 16C and 16D of the second light guide plate 16. The first light guide plate 14 is provided with a dot pattern in the first area 14E that is a remaining area with the exception of the second area 14F as one partial area of the main surface 14B. The dot pattern provided in the first area 14E is only required to be an example of a first light distribution control structure that reflects or scatters visible light incident on the edge surface 14C of the first light guide plate 14 from the first light source. The second light guide plate 16 is provided with a dot pattern in the second area 16F that is one partial area of the main surface 16B. The dot pattern provided in the second area 16F is only required to be an example of a second light distribution control structure that reflects or scatters visible light incident on one or both of the edge surfaces 16C and 16D of the second light guide plate 16 from the second light source. The second area 16F where the dot pattern is provided is capable of transmitting at least a portion of infrared light having propagated inside the second light guide plate 16. Because of this configuration, when the infrared camera 11 is arranged, a suitable display can be achieved.

### Embodiment 3

A liquid crystal display device 10 may include an optical functional film that is capable of transmitting infrared light and reflecting visible light to prevent an infrared camera 11 from being visually recognized from the outside. The optical functional film as described above is only required to be an optical functional film that has an appropriate arrangement and size between the infrared camera 11 and a second light guide plate 16.

As an example, the optical functional film may have a size that enables an FOV area of the infrared camera 11 corresponding to an angle θ illustrated in FIG. 4 to be covered. In this case, the optical functional film may be arranged between the infrared camera 11 and a rear chassis 12. Alternatively, the optical functional film may be arranged between the rear chassis 12 and a reflection sheet 13. Still alternatively, the optical functional film may be arranged between the reflection sheet 13 and a first light guide plate 14. Still alternatively, the optical functional film may be arranged between the first light guide plate 14 and an optical sheet 15. Still alternatively, the optical functional film may be arranged between a plurality of sheet members included in the optical sheet 15. Still alternatively, the optical functional film may be arranged between the optical sheet 15 and a second light guide plate 16.

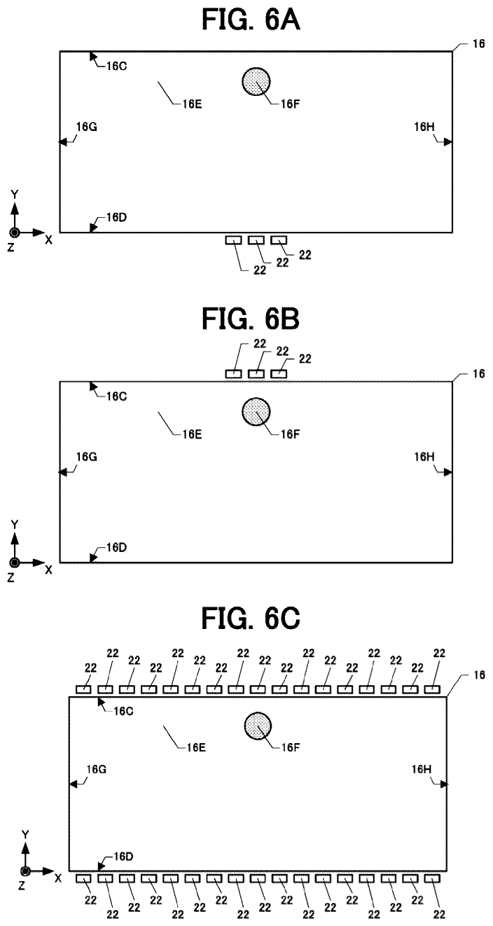

FIG. 7 is a cross-sectional view illustrating a configuration example in which an optical functional film 31 is arranged between the optical sheet 15 and the second light guide plate 16. The optical functional film 31 in FIG. 7 is positioned adjacent to the second light guide plate 16 on the −Z-direction side that is the rear side. The optical functional film 31 is only required to have a size that is smaller than an entire opening in a front chassis 17 and that enables the FOV area of the infrared camera 11 to be covered. By arranging the optical functional film 31 between the optical sheet 15 and the second light guide plate 16, it is possible to prevent the infrared camera 11 from being visually recognized from the outside and also improve uniformity of a backlight.

As another example, the optical functional film may have a size matching the entire opening in the front chassis 17. In this case, the optical functional film is only required to be arranged on the −Z direction side that is the rear side of the first light guide plate 14. More specifically, the optical functional film may be arranged between the rear chassis 12 and the reflection sheet 13. Alternatively, the optical functional film may be arranged between the reflection sheet 13 and the first light guide plate 14. As described above, the optical functional film that can transmit infrared light and reflect visible light is only required to be provided at different positions according to size.

In Embodiment 3, the second light guide plate 16 also overlaps the first light guide plate 14 in a direction of a main surface 14A that is a direction perpendicular to a main surface of the first light guide plate 14, that is, the Z-axis direction. A first light source including the plurality of first light emitting elements 21 emits visible light to be incident on an edge surface 14C of the first light guide plate 14. A second light source including a plurality of second light emitting elements 22 emits visible light to be incident on edge surfaces 16C and 16D of the second light guide plate 16. The first light guide plate 14 is provided with a dot pattern in a first area 14E that is a remaining area with the exception of a second area 14F as one partial area of a main surface 14B. The dot pattern provided in the first area 14E is only required to be an example of a first light distribution control structure that reflects or scatters visible light incident on the edge surface 14C of the first light guide plate 14 from the first light source. The second light guide plate 16 is provided with a dot pattern in the second area 16F that is one partial area of the main surface 16B. The dot pattern provided in the second area 16F is only required to be an example of a second light distribution control structure that reflects or scatters visible light incident on the edge surfaces 16C and 16D of the second light guide plate 16 from the second light source. The second area 16F where the dot pattern is provided is capable of transmitting at least a portion of infrared light having propagated inside the second light guide plate 16. Because of this configuration, when the infrared camera 11 is arranged, a suitable display can be achieved.

### Embodiment 4

A lighting unit of a liquid crystal display device 10 may include a visible light diffusion film that is capable of transmitting infrared light and diffusing visible light. Such a visible light diffusion film is only required to be a visible light diffusion film that has an appropriate arrangement and size on a light emitting surface of a lighting unit included in the liquid crystal display device 10.

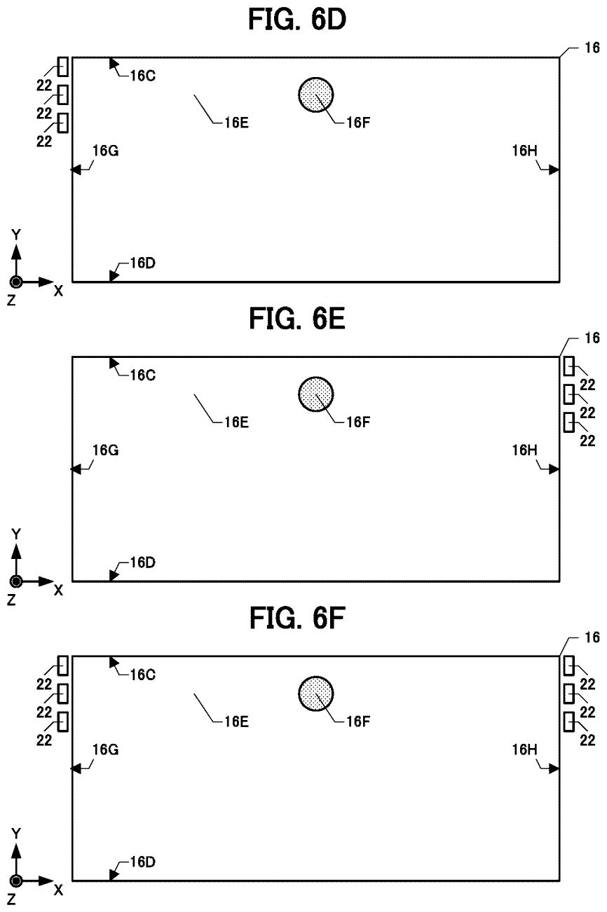

FIG. 8 is a cross-sectional view illustrating a configuration example in which a visible light diffusion film 32 is arranged on a front surface on the outer side of a second light guide plate 16. The visible light diffusion film 32 in FIG. 8 is positioned on a side closer to a liquid crystal panel 18 than a main surface 16B of the second light guide plate 16 where a dot pattern is provided. In other words, the visible light diffusion film 32 is arranged on the +Z-direction side that is the front side of a first light guide plate 14 and the second light guide plate 16. The lighting unit of the liquid crystal display device 10 includes the visible light diffusion film 32 on a light emitting surface that is an outermost surface. The visible light diffusion film 32 is only required to have a size matching an entire opening in a front chassis 17. Since the visible light diffusion film 32 diffuses visible light, the dot pattern provided in a second area 16F included in the main surface 16B of the second light guide plate 16 becomes difficult to be visually recognized from the outside. Therefore, the liquid crystal display device 10 is capable of achieving a suitable display when an infrared camera 11 is arranged using a backlight with improved uniformity.

### Embodiment 5

In a lighting unit of a liquid crystal display device 10, as long as the lighting unit has a configuration in which an optical sheet 15 is provided on the +Z-direction side that is the front side of a first light guide plate 14, an arrangement of the first light guide plate 14 and a second light guide plate 16 that overlap each other in the Z-axis direction that is the front-rear direction may be changed. For example, the optical sheet 15 may be arranged at the forward most position on the +Z-direction side in the lighting unit of the liquid crystal display device 10, and either an arrangement in which the first light guide plate 14 is arranged on the front side of the second light guide plate 16 or an arrangement in which the second light guide plate 16 is arranged on the front side of the first light guide plate 14 may be employed.

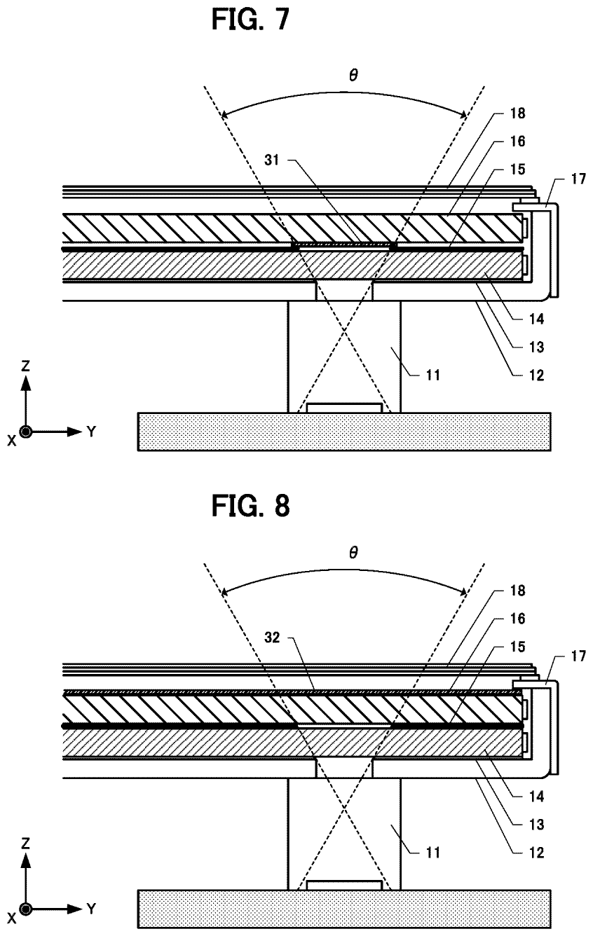

FIG. 9A is a cross-sectional view illustrating a configuration example in which the first light guide plate 14 is arranged on the front side of the second light guide plate 16. In this case, in the lighting unit of the liquid crystal display device 10, a reflection sheet 13, the second light guide plate 16, the first light guide plate 14, and the optical sheet 15 are arranged in this order from the −Z-direction side that is the rear side toward the +Z direction side that is the front side. In the second light guide plate 16 illustrated in FIG. 9A, visible light reflected to the +Z-direction side that is the front side by a dot pattern provided in a second area 16F of a main surface 16B is emitted from a main surface 16A of the second light guide plate 16 to the +Z-direction side that is the front side. In the first light guide plate 14 illustrated in FIG. 9A, visible light reflected to the +Z-direction side that is the front side by a dot pattern provided in a first area 14E of a main surface 14B is emitted from a main surface 14A of the first light guide plate 14 to the +Z-direction side that is the front side. Therefore, visible light having propagated inside the first light guide plate 14 is emitted from a range of the main surface 14A corresponding to the first area 14E where the dot pattern is provided. In contrast, in the first light guide plate 14, a range of the main surface 14A corresponding to a second area 14F where no dot pattern is provided is only required to emit visible light that is emitted from the main surface 16A of the second light guide plate 16 and is incident on the main surface 14B of the first light guide plate 14. The visible light emitted from the main surface 14A of the first light guide plate 14 illustrated in FIG. 9A in this manner is transmitted through the optical sheet 15 or passes through a through-hole 15H provided in the optical sheet 15 and is subsequently provided to a liquid crystal panel 18.

FIG. 9B is a cross-sectional view illustrating a configuration example in which the second light guide plate 16 is arranged on the front side of the first light guide plate 14. In this case, in the lighting unit of the liquid crystal display device 10, the reflection sheet 13, the first light guide plate 14, the second light guide plate 16, and the optical sheet 15 are arranged in this order from the −Z-direction side that is the rear side toward the +Z direction side that is the front side. In the first light guide plate 14 illustrated in FIG. 9B, visible light reflected to the +Z-direction side that is the front side by the dot pattern provided in the first area 14E of the main surface 14B is emitted from the main surface 14A of the first light guide plate 14 to the +Z-direction side that is the front side. In the second light guide plate 16 illustrated in FIG. 9B, visible light reflected to the +Z-direction side that is the front side by the dot pattern provided in the second area 16F of the main surface 16B is emitted from the main surface 16A of the second light guide plate 16 to the +Z-direction side that is the front side. Therefore, visible light having propagated inside the second light guide plate 16 is emitted from a range of the main surface 16A corresponding to the second area 16F where the dot pattern is provided. In contrast, in the second light guide plate 16, a range of the main surface 16A corresponding to a first area 16E where no dot pattern is provided is only required to emit visible light that is emitted from the main surface 14A of the first light guide plate 14 and is incident on the main surface 16B of the second light guide plate 16. The visible light emitted from the main surface 16A of the second light guide plate 16 illustrated in FIG. 9B in this manner is transmitted through the optical sheet 15 or passes through the through-hole 15H provided in the optical sheet 15 and is subsequently provided to the liquid crystal panel 18.

In either case, the through-hole 15H provided in the optical sheet 15 is only required to be an opening that has a size greater than or equal to an FOV area corresponding to an angle θ. The second area 14F on the main surface 14B of the first light guide plate 14 is only required to have a size that is greater than or equal to the FOV area corresponding to the angle θ. The second area 16F on the main surface 16B of the second light guide plate 16 is only required to have a size that is greater than or equal to the FOV area corresponding to the angle θ.

In Embodiment 5, the second light guide plate 16 overlaps the first light guide plate 14 in a direction of the main surface 14A or the main surface 14B that is a direction perpendicular to a main surface of the first light guide plate 14, that is, the Z-axis direction. A first light source including a plurality of first light emitting elements 21 emits visible light to be incident on an edge surface 14C of the first light guide plate 14. A second light source including a plurality of second light emitting elements 22 emits visible light to be incident on edge surfaces 16C and 16D of the second light guide plate 16. The first light guide plate 14 is provided with a dot pattern in the first area 14E that is a remaining area with the exception of the second area 14F as one partial area of the main surface 14B. The dot pattern provided in the first area 14E is only required to be an example of a first light distribution control structure that reflects or scatters visible light incident on the edge surface 14C of the first light guide plate 14 from the first light source. The second light guide plate 16 is provided with a dot pattern in the second area 16F that is one partial area of the main surface 16B. The dot pattern provided in the second area 16F is only required to be an example of a second light distribution control structure that reflects or scatters visible light incident on the edge surfaces 16C and 16D of the second light guide plate 16 from the second light source. The second area 16F where the dot pattern is provided is capable of transmitting at least a portion of infrared light having propagated inside the second light guide plate 16. Because of this configuration, when an infrared camera 11 is arranged, a suitable display can be achieved.

### Embodiment 6

A lighting unit of a liquid crystal display device 10 may include a first light guide plate 14 as a single light guide plate. In this case, a second light guide plate 16 is replaced by a light guide member having a shape different from a plate shape. The light guide member is only required to be a light guide member that has a shape covering an infrared camera 11. A plurality of second light emitting elements is only required to be light emitting elements that is arranged to be able to supply visible light to be incident into the inside of the light guide member. The other constituent components, such as the first light guide plate 14 and a plurality of first light emitting elements 21, are only required to be the same as those in the above-described embodiments in whole or in part.

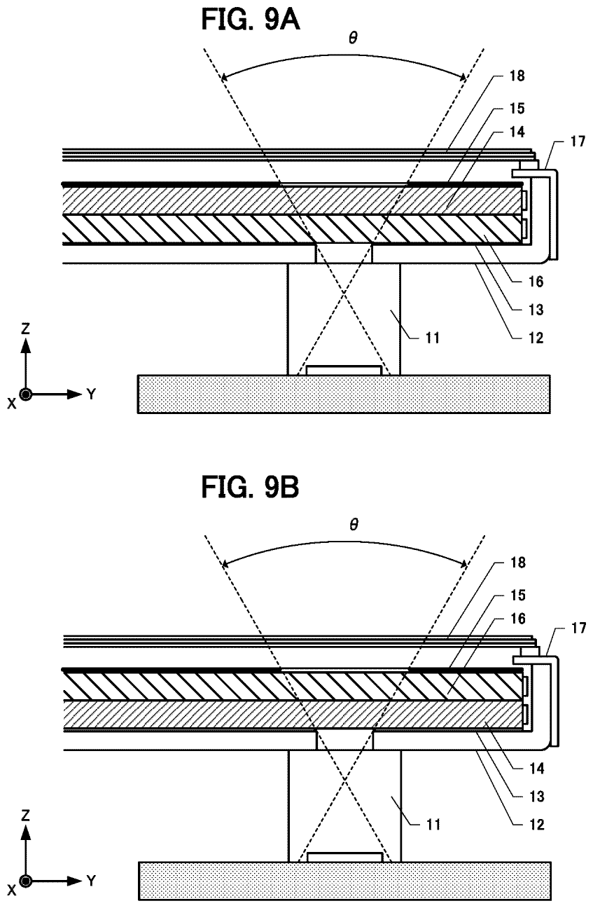

FIG. 10 is a cross-sectional view illustrating a configuration example in which a light guide member 35 that replaces the second light guide plate 16 and a plurality of second light emitting elements 41 are included. The light guide member 35 in FIG. 10 is arranged adjacent to the infrared camera 11. A rear chassis 12 and a reflection sheet 13 are arranged on the −Z-direction side that is the rear side of the first light guide plate 14 and on the +Z-direction side that is the front side of all or a portion of the light guide member 35. The rear chassis 12, the reflection sheet 13, and the optical sheet 15 are only required to have through-holes that serve as openings matching an FOV of the infrared camera 11, as with the other embodiments.

The light guide member 35 includes a light incident surface 35A, a light distribution control surface 35B, a light emitting surface 35C, an outer circumferential surface 35D1, and an inner circumferential surface 35D2. The light guide member 35 is provided with a dot pattern serving as a light distribution control structure on all or a portion of the light distribution control surface 35B. The light distribution control surface 35B of the light guide member 35 is only required to be capable of controlling a light distribution direction of visible light to the light emitting surface 35C side, that is, the +Z-direction side that is the front side, by reflection or scattering of visible light propagating inside the light guide member 35. The light distribution control surface 35B is only required to have a dot pattern serving as a second light distribution control structure in an area that has a size determined in accordance with the FOV of the infrared camera 11. Additionally, the dot pattern provided on the light distribution control surface 35B of the light guide member 35 is only required to be a dot pattern that has similar characteristics to the dot pattern provided in the second area 16F of the main surface 16B of the second light guide plate 16 in the above-described embodiments.

The plurality of second light emitting elements 41 is provided adjacent to the light incident surface 35A of the light guide member 35, and emits visible light to be incident on the light guide member 35. The plurality of second light emitting elements 41 is only required to constitute a second light source and be controllable to a current value or a luminous flux value that is different from that of the plurality of first light emitting elements 21. Visible light output from the plurality of second light emitting elements 41 and incident on the light incident surface 35A of the light guide member 35 propagates inside the light guide member 35 while repeating total reflection at the outer circumferential surface 35D1 and the inner circumferential surface 35D2. The visible light having propagated inside the light guide member 35 reaches the light distribution control surface 35B where the dot pattern is provided. Therefore, the light guide member 35 is capable of emitting incident visible light to the +Z-direction side that is the front side. A main surface 14B of the first light guide plate 14 is, as with the other embodiments, only required to have a dot pattern serving as a first light distribution control structure in a first area 14E, with the exception of a second area 14F as one partial area that has a size matching the FOV of the infrared camera 11.

The light guide member 35 is only required to be made of the same material as the first light guide plate 14. Note that the light guide member 35 may be made of a material that is different from the material of the first light guide plate 14 and that has a high transmittance for visible light. The outer circumferential surface 35D1 and the inner circumferential surface 35D2 of the light guide member 35 are only required to be produced by being subjected to coating treatment using a reflective material, and is only required to reflect visible light incident on the light incident surface 35A in such a manner as not to emit the visible light. The coating treatment is only required to be treatment in which a thin film is coated using a metal with a high light reflection rate, such as silver or aluminum.

The infrared camera 11 is provided on the −Z direction side that is the rear side of the first light guide plate 14 and the light guide member 35. The light guide member 35 is only required to be capable of transmitting at least a portion of infrared light through the light distribution control surface 35B that serves as one partial area where the dot pattern is provided. The infrared camera 11 is only required to be capable of performing imaging using infrared light that is transmitted through the light distribution control surface 35B of the light guide member 35.

An optical functional film that is capable of transmitting infrared light and reflecting visible light may be arranged between the infrared camera 11 and the light distribution control surface 35B of the light guide member 35. The optical functional film is only required to have a size that allows an FOV area of the infrared camera 11 to be covered. A visible light diffusion film that is capable of transmitting infrared light and diffusing visible light may be arranged on the +Z-direction side that is the front side of the first light guide plate 14 and the light guide member 35. The visible light diffusion film is, as with Embodiment 4, only required to have a size matching an entire opening in a front chassis 17.

In Embodiment 6, the light guide member 35 is arranged in a direction of the main surface 14B that is a direction perpendicular to a main surface of the first light guide plate 14, that is, the Z-axis direction. Therefore, the light guide member 35 is arranged in the direction perpendicular to a main surface of the first light guide plate 14 serving as a single light guide plate. A first light source including the plurality of first light emitting elements 21 emits visible light to be incident on an edge surface 14C of the first light guide plate 14. The second light source including the plurality of second light emitting elements 41 emits visible light to be incident on the light guide member 35. The first light guide plate 14 is provided with a dot pattern in the first area 14E that is a remaining area with the exception of the second area 14F as one partial area of the main surface 14B. The dot pattern provided in the first area 14E is only required to be an example of a first light distribution control structure that reflects or scatters visible light incident on the edge surface 14C of the first light guide plate 14 from the first light source. The light guide member 35 is provided with a dot pattern on all or a portion of the light distribution control surface 35B serving as one partial area. The dot pattern provided on the light distribution control surface 35B is only required to be an example of the second light distribution control structure that reflects or scatters visible light incident on the inside of the light guide member 35 from the second light source. The light distribution control surface 35B where the dot pattern is provided is capable of transmitting at least a portion of infrared light having propagated inside the light guide member 35. Because of this configuration, when the infrared camera 11 is arranged, a suitable display can be achieved.

### Embodiment 7

In a display unit of a liquid crystal display device 10, a liquid crystal panel 18 may be configured including a plurality of liquid crystal display panels. In this case, at least one liquid crystal display panel may have a light blocking pattern that has light blocking properties. The light blocking pattern is repeatedly arranged. The light blocking pattern may include a first light blocking pattern that is made using a plurality of scan wirings and a second light blocking pattern that is made using a plurality of signal wirings.

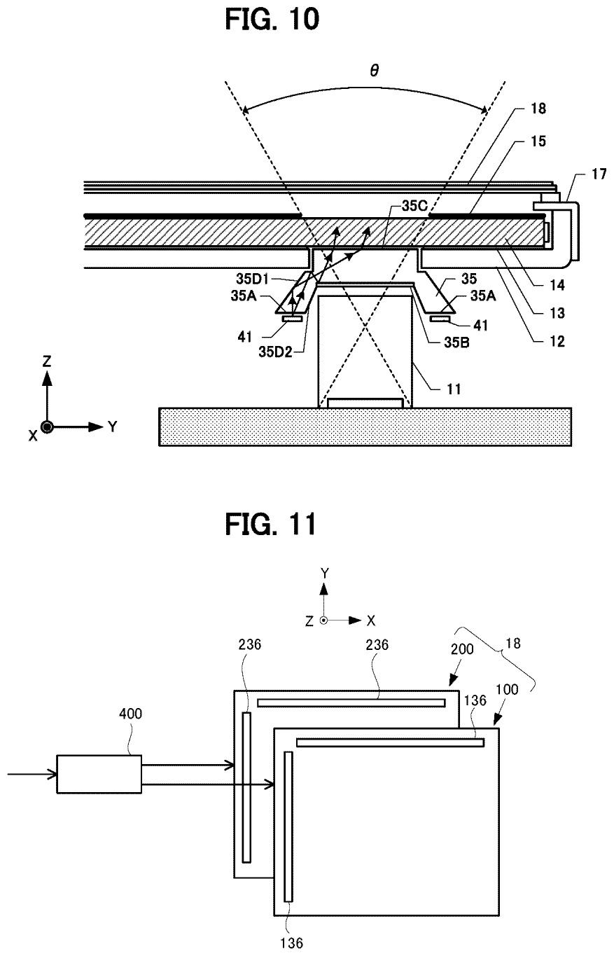

FIG. 11 illustrates a configuration example of the liquid crystal panel 18 and the like in Embodiment 7. The liquid crystal panel 18 in FIG. 11 includes a first liquid crystal display panel 100 and a second liquid crystal display panel 200. Displays on the first liquid crystal display panel 100 and the second liquid crystal display panel 200 are controlled by a display controller 400. The first liquid crystal display panel 100 is arranged on the +Z-direction side that is the front side and displays a color image. The second liquid crystal display panel 200 is arranged on the −Z-direction side that is the rear side and overlaps the first liquid crystal display panel 100. The second liquid crystal display panel 200 displays a monochrome image.

The first liquid crystal display panel 100 is only required to include a first driver circuit 136 and be able to be configured including a first TFT substrate, a first counter substrate, a first liquid crystal, a first polarizing plate, and a second polarizing plate. The first TFT substrate and the first counter substrate clamp the first liquid crystal. The first polarizing plate is provided on the first TFT substrate, and the second polarizing plate is provided on the first counter substrate.

The second liquid crystal display panel 200 is only required to include a second driver circuit 236 and be able to be configured including a second TFT substrate, a second counter substrate, a second liquid crystal, and a third polarizing plate. The second TFT substrate and the second counter substrate clamp the second liquid crystal. The third polarizing plate is provided on the second TFT substrate. The first polarizing plate of the first liquid crystal display panel 100 is only required to also serve as a polarizing plate on a light emitting side of the second liquid crystal display panel 200. The second liquid crystal display panel 200 does not include a color filter and a black matrix.

The second liquid crystal display panel 200 includes main pixels arranged in a matrix. For example, one main pixel of the second liquid crystal display panel 200 corresponds to 16 (4×4) main pixels of the first liquid crystal display panel 100. In this case, one main pixel of the second liquid crystal display panel 200 emits light to 16 main pixels of the first liquid crystal display panel 100.

In the second liquid crystal display panel 200, the plurality of scan wirings serving as the first light blocking pattern is only required to individually extend along the X-axis direction and be arranged separated from each other in the Y-axis direction. A pair of scan wirings extend in the X-axis direction and constitute a first light blocking pattern having light blocking properties.

The first light blocking pattern is repeatedly arranged in the Y-axis direction. The light blocking properties mean blocking at least a portion of light incident from a lighting unit of the liquid crystal display device 10. The X-axis direction corresponds to a predetermined direction in the first light blocking pattern.

One scan wiring of a pair of adjacent scan wirings is a first light blocking line. The first light blocking line includes a first inclined section, a second inclined section, and a first flat section. The first inclined section is inclined at an acute angle in a counterclockwise direction with respect to the +X-direction. The second inclined section is inclined at an acute angle in an opposite direction to the first inclined section, that is, a clockwise direction, with respect to the +X-direction. The first flat section extends parallel to the X-axis direction. The first flat section connects to the first inclined section and the second inclined section.

The other scan wiring of the pair of adjacent scan wirings is a second light blocking line. The second light blocking line includes a third inclined section, a fourth inclined section, and a second flat section. The second light blocking line is line-symmetric to the first light blocking line with respect to the X-axis direction. The third inclined section is opposed to the first inclined section of the first light blocking line and inclined at an acute angle in the clockwise direction with respect to the +X-direction. The fourth inclined section is opposed to the second inclined section of the first light blocking line and inclined at an acute angle in an opposite direction to the third inclined section, that is, the counterclockwise direction, with respect to the +X-direction. The second flat section extends parallel to the X-axis direction. The second flat section is opposed to the first flat section of the first light blocking line. The second flat section connects to the third inclined section and the fourth inclined section.

Distance between the first light blocking line and the second light blocking line continuously changes between the first inclined section of the first light blocking line and the third inclined section of the second light blocking line. The distance between the first light blocking line and the second light blocking line continuously changes between the second inclined section of the first light blocking line and the fourth inclined section of the second light blocking line. The distance between the first flat section of the first light blocking line and the second flat section of the second light blocking line is either a first distance or a second distance that is different from the first distance. Because of this configuration, when the second liquid crystal display panel 200 is overlaid on the first liquid crystal display panel 100, interference of spatial frequencies between the first liquid crystal display panel 100 and the second liquid crystal display panel 200 is suppressed, and moire of the liquid crystal display device 10 can thereby be suppressed.

In the second liquid crystal display panel 200, the plurality of signal wirings serving as the second light blocking pattern is only required to individually extend along the Y-axis direction and be arranged separated from each other in the X-axis direction. A pair of signal wirings extend in the Y-axis direction and shape a second light blocking pattern having light blocking properties. The second light blocking pattern is repeatedly arranged in the X-axis direction. The Y-axis direction corresponds to a predetermined direction in the second light blocking pattern.

One signal wiring of a pair of adjacent signal wirings is a third light blocking line. The third light blocking line includes a fifth inclined section and a sixth inclined section. The fifth inclined section is inclined at an acute angle in the counterclockwise direction with respect to the +Y-direction. The sixth inclined section is inclined at an acute angle in an opposite direction to the fifth inclined section, that is, the clockwise direction, with respect to the +Y-direction.

The other signal wiring of the pair of adjacent signal wirings is a fourth light blocking line. The fourth light blocking line includes a seventh inclined section and an eighth inclined section. The fourth light blocking line is line-symmetric to the third light blocking line with respect to the Y-axis direction. The seventh inclined section is opposed to the fifth inclined section of the third light blocking line and inclined at an acute angle in the clockwise direction with respect to the +Y-direction. The eighth inclined section is opposed to the sixth inclined section of the third light blocking line and inclined at an acute angle in an opposite direction to the seventh inclined section, that is, the counterclockwise direction, with respect to the +Y-direction.

Distance between the third light blocking line and the fourth light blocking line continuously changes. Because of this configuration, when the second liquid crystal display panel 200 is overlaid on the first liquid crystal display panel 100, interference of spatial frequencies between the first liquid crystal display panel 100 and the second liquid crystal display panel 200 is suppressed, and moire of the liquid crystal display device 10 can thereby be suppressed.

The first liquid crystal display panel 100 includes main pixels arranged in a matrix. Each of the main pixels includes a red pixel, a green pixel, and a blue pixel. The red pixel, the green pixel, and the blue pixel are defined in a V-shape by a black matrix. The red pixel emits red light. The green pixel emits green light. The blue pixel emits blue light. The red pixel, the green pixel, and the blue pixel are collectively referred to as sub-pixels. A color filter of the first liquid crystal display panel 100 has a plurality of filter elements arranged in a stripe shape. For example, filter elements with the same color in the color filter are arranged in the Y-axis direction. In this case, the color filter has a stripe direction aligned with the Y-axis direction. The color filter includes, as the plurality of filter elements, a red color filter, a green color filter, and a blue color filter. The red color filter, the green color filter, and the blue color filter are each surrounded by a black matrix and correspond to a red pixel, a green pixel, and a blue pixel, respectively.

In the second liquid crystal display panel 200, the first light blocking pattern is provided along the X-axis direction. A first light blocking line included in the first light blocking pattern has a first inclined section and a second inclined section inclined across a plurality of different sub-pixels of the first liquid crystal display panel 100. A second light blocking line included in the first light blocking pattern has a third inclined section and a fourth inclined section inclined across a plurality of different sub-pixels of the first liquid crystal display panel 100. Because of this configuration, the display unit of the liquid crystal display device 10 is capable of suppressing recognition of color moire by an observer across the entire display. A first flat section of a first light blocking line and a second flat section of a second light blocking line are only required to overlap a black matrix of the first liquid crystal display panel 100.

In the second liquid crystal display panel 200, the second light blocking pattern is provided along the Y-axis direction. A third light blocking line included in the second light blocking pattern has a fifth inclined section and a sixth inclined section inclined across a plurality of sub-pixels of different colors of the first liquid crystal display panel 100. A fourth light blocking line included in the second light blocking pattern has a seventh inclined section and an eighth inclined section inclined across a plurality of sub-pixels of different colors of the first liquid crystal display panel 100. Because of this configuration, the display unit of the liquid crystal display device 10 is capable of suppressing recognition of color moire by the observer across the entire display.

The color filter of the first liquid crystal display panel 100 has filter elements of the same color arranged in the Y-axis direction. A first flat section in a first light blocking line and a second flat section in a second light blocking line of the first light blocking pattern are both provided parallel to the X-axis direction. Therefore, the stripe direction of the color filter provided on the first liquid crystal display panel 100 is perpendicular to the direction in which both of a first flat section in a first light blocking line and a second flat section in a second light blocking line in the light blocking pattern provided on the second liquid crystal display panel 200 extend. Because of this configuration, it is possible to prevent the first light blocking lines and the second light blocking lines from blocking a large amount of light incident on sub-pixels of a specific color, and thereby prevent occurrence of a color shift.

The second liquid crystal display panel 200 includes main pixels arranged in a matrix. For example, one main pixel of the second liquid crystal display panel 200 corresponds to 16 (4×4) main pixels of the first liquid crystal display panel 100. In this case, one main pixel of the second liquid crystal display panel 200 emits light to 16 main pixels of the first liquid crystal display panel 100.

The display controller 400 includes an image data distributor, a first image signal generator, a second image brightness signal generator, and a second image signal generator. The image data distributor distributes input image data to the first image signal generator and the second image brightness signal generator. The first image signal generator generates, using the input image data, a color image to be displayed on the first liquid crystal display panel 100.

The second image brightness signal generator generates, using the input image data, brightness signals corresponding to a monochrome image to be displayed on the second liquid crystal display panel 200. For example, a brightness level of one main pixel of the second liquid crystal display panel 200 is only required to be determinable based on an average value, a frequency value, a minimum value, a maximum value, or the like of red gradation values, green gradation values, and blue gradation values of 16 main pixels of the first liquid crystal display panel 100 on which light emitted from the main pixel of the second liquid crystal display panel 200 is incident. In addition, the brightness level of one main pixel of the second liquid crystal display panel 200 may be determinable using light intensity of visible light incident on each of the plurality of main pixels in the second liquid crystal display panel 200 from the lighting unit. The determined brightness level may be a gradation value. The second image brightness signal generator sends brightness signals representing brightness levels to the second image signal generator.

The second image signal generator generates, using the brightness signals, a monochrome image to be displayed on the second liquid crystal display panel 200. For example, the second image signal generator generates a monochrome image that has been subjected to averaging processing and gradation conversion.

The number of main pixels of the first liquid crystal display panel 100 corresponding to one main pixel of the second liquid crystal display panel 200 may be set to an arbitrary number. The second liquid crystal display panel 200 is only required to include at least one of the first light blocking pattern and the second light blocking pattern.

It is only required that to a more detailed configuration and operation of the display unit of the liquid crystal display device 10, technical features described in, for example, Japanese Patent No. 5176194 or Unexamined Japanese Patent Application Publication No. 2023-117257 be applicable.

### Other Variations

The lighting unit of the liquid crystal display device 10 is not limited to a lighting unit providing visible light using the first light guide plate 14, and, for example, one of a light emitting structure using a light emitting device, a light refracting structure using a prism structure, a light reflecting structure using a mirror structure, a light converging structure using a lens structure, and a light diffusing structure using a diffusing element, a combination of all or some of the foregoing, or any other structure capable of providing visible light may be used. In this case, the structure that provides visible light emitted from the first area of the light emitting surface in the lighting unit of the liquid crystal display device 10, the first area serving as a range corresponding to the first area 14E of the main surface 14B in the first light guide plate 14, is only required to serve as an example of the first lighting. In contrast, the second light guide plate 16 is only required to be arranged in such a manner as to overlap the first lighting in the same direction as the direction in which the light emitting surface is arranged, such as the +Z-direction side that is the front side of the first light guide plate 14 illustrated in, for example, FIGS. 3 and 4, or in the opposite direction to the direction in which the light emitting surface is arranged, such as the −Z-direction side that is the rear side of the first light guide plate 14 illustrated in, for example, FIG. 9A, in the lighting unit of the liquid crystal display device 10. In addition, the second light guide plate 16 is only required to serve as an example of the second lighting that provides visible light emitted from a range, the range serving as a second area at least a portion of which is different from the first area of the light emitting surface and corresponding to the second area 16F of the main surface 16B. The light guide member 35 that replaces the second light guide plate 16 is only required to be arranged in the opposite direction to the direction in which the light emitting surface is arranged with respect to the first light guide plate 14, such as the −Z direction side that is the rear side of the first light guide plate 14 illustrated in, for example, FIG. 10. In addition, the light guide member 35 is only required to serve as an example of the second lighting that provides visible light emitted from a range, the range serving as a second area at least a portion of which is different from the first area of the light emitting surface and corresponding to the light emitting surface 35C. As described above, the second lighting using the second light guide plate 16 or the light guide member 35 is only required to be a lighting arranged in the same direction as or the opposite direction to the direction in which the light emitting surface is arranged with respect to the first lighting.

The first lighting and the second lighting overlapping each other means that one of the main surfaces of the plate-shaped first lighting and one of the main surfaces of the plate-shaped second lighting face each other in whole or in part. The light emitting surface of the lighting unit of the liquid crystal display device 10 is positioned on the +Z-direction side that is the front side. When the first lighting and the second lighting overlap each other, one of the first lighting and the second lighting is arranged on the −Z-direction side that is the rear side, and the other is arranged on the +Z-direction side that is the front side. The first area of the first lighting is only required to correspond to the first area 14E having a dot pattern in the first light guide plate 14 illustrated in, for example, FIGS. 3 and 5D. The second area of the second lighting is only required to correspond to the second area 16F having a dot pattern in the second light guide plate 16 illustrated in, for example, FIGS. 3 and 5E or the light distribution control surface 35B having a dot pattern in the light guide member 35 illustrated in FIG. 10. The first area of the first lighting and the second area of the second lighting may correspond to the first emitting area and the second emitting area of the light emitting surface in the above-described embodiments, respectively. The lighting unit of the liquid crystal display device 10 is only required to be capable of providing visible light with uniform brightness across the light emitting surface through synthesis of visible light emitted from the first area of the first lighting and visible light emitted from the second area of the second lighting. It is only required to enable the observer viewing the lighting unit of the liquid crystal display device 10 from the outside of the light emitting surface to recognize visible light emitted from the entire surface of the light emitting surface through a combination of the first area of the first lighting and the second area of the second lighting.

The infrared camera 11 is only required to be an infrared camera that is provided at an arbitrary position on the −Z-direction side that is the rear side of the lighting unit of the liquid crystal display device 10. For example, the infrared camera 11 may be, instead of an infrared camera provided in a central upper portion of the rear chassis 12 like the infrared camera 11 in the above-described embodiments, any of an infrared camera provided in a right upper portion, an infrared camera provided in a right lower portion, an infrared camera provided at an arbitrary other right-hand side position, an infrared camera provided in a left upper portion, an infrared camera provided in a left lower portion, infrared camera provided at an arbitrary other left-hand side position, an infrared camera provided in a central lower portion, an infrared camera provided in a central portion in the right-left and up-down directions, and an infrared camera provided at an arbitrary other central position. In order to secure visibility of camera images for each of the above-described positions of the infrared camera 11, it is only required that the positions and sizes of the through-holes 12H, 13H, and 15H and the position and size of the second area 16F on the main surface 16B of the second light guide plate 16 be able to be determined based on the position of the infrared camera 11. Likewise, it is only required that the position and size of an area where the dot pattern is provided on the light distribution control surface 35B of the light guide member 35 be also able to be determined based on each of the above-described positions of the infrared camera 11. The infrared camera 11 provided at an arbitrary position is only required to be capable of performing imaging using infrared light transmitted through the second area of the second lighting. The second lighting is only required to be capable of transmitting infrared light used for imaging by the infrared camera 11 through the second area where the dot pattern is provided, as with the second area 16F having a dot pattern on the second light guide plate 16 illustrated in, for example, FIGS. 3 and 5E or the light distribution control surface 35B having a dot pattern in the light guide member 35 illustrated in FIG. 10.

In the first light guide plate 14 or the second light guide plate 16, a dot pattern serving as a light distribution control structure that reflects or scatters visible light may be provided on a main surface on the +Z-direction side that is the front side to which visible light is emitted, as long as the position of the dot pattern is a position that does not influence the focus of the infrared camera 11. For example, in the first light guide plate 14, a dot pattern may be provided in, in place of the first area 14E of the main surface 14B, an area of the main surface 14A corresponding to the first area 14E. In this case, the first light guide plate 14 is provided with a dot pattern serving as the first light distribution control structure on the main surface 14A with the exception of one partial area of the main surface 14A. The diameter of the area where no dot pattern is provided on the main surface 14A of the first light guide plate 14 is only required to be determinable by the mathematical formula in Embodiment 1 using the angle θ, with the thickness of the first light guide plate 14 included in the thicknesses tₖ of the constituent members. In the second light guide plate 16, a dot pattern may be provided in, in place of the second area 16F of the main surface 16B, an area of the main surface 16A corresponding to the second area 16F. In this case, the second light guide plate 16 is provided with a dot pattern serving as the second light distribution control structure in one partial area of the main surface 16A. The diameter of the area where the dot pattern is provided on the main surface 16A of the second light guide plate 16 is only required to be determinable by the mathematical formula in Embodiment 1 using the angle θ, with the thickness of the second light guide plate 16 included in the thicknesses tₖ of the constituent members.

In the light guide member 35 illustrated in FIG. 10, a dot pattern serving as a light distribution control structure that reflects or scatters visible light may be provided on the +Z-direction side that is the front side to which visible light is emitted, as long as the position of the dot pattern is a position that does not influence the focus of the infrared camera 11. For example, in the light guide member 35, a dot pattern may be provided on all or a portion of the light emitting surface 35C, instead of the light distribution control surface 35B. In this case, the light emitting surface 35C is only required to have a dot pattern serving as the second light distribution control structure in an area that has a size determined in accordance with the FOV of the infrared camera 11. Additionally, the dot pattern provided on the light emitting surface 35C of the light guide member 35 is only required to be a dot pattern that has similar characteristics to the dot pattern provided in the one partial area of the main surface 16A of the second light guide plate 16.

The liquid crystal display device 10 of the present disclosure is only required to be applicable to, representatively, a liquid crystal display meter of a vehicle. Alternatively, the liquid crystal display device 10 may be applied to a display device that an airplane, a train, a machine tool, or any other machine involving operation manipulation. Without being limited to a machine involving operation manipulation, the liquid crystal display device 10 may be applied to an arbitrary electronic terminal requiring display of an image.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A lighting device, comprising:
a light guide plate;
a light guide member that is arranged in a direction perpendicular to a main surface of the light guide plate;
a first light source that emits visible light to be incident on an edge surface of the light guide plate; and
a second light source that emits visible light to be incident on the light guide member,
wherein the light guide plate is provided with a first light distribution control structure, the first light distribution control structure reflecting or scattering visible light incident on an edge surface from the first light source, on a main surface with the exception of one partial area of the main surface, and
the light guide member is provided with a second light distribution control structure, the second light distribution control structure reflecting or scattering visible light incident from the second light source and being also capable of transmitting at least a portion of infrared light, in one partial area.

2. The lighting device according to claim 1, wherein
the light guide plate and the light guide member are capable of emitting incident visible light to a front side, and
the lighting device includes an infrared camera that is provided on a rear side of the light guide plate and the light guide member and is capable of performing imaging using infrared light transmitted through the one partial area of the light guide member where the second light distribution control structure is provided.

3. The lighting device according to claim 2, wherein the one partial area on a main surface of the light guide plate where the first light distribution control structure is provided and the one partial area of the light guide member where the second light distribution control structure is provided are arranged in accordance with an FOV of the infrared camera and have sizes matching the FOV of the infrared camera.

4. The lighting device according to claim 2, comprising:
a rear support member and a reflection sheet that are arranged on a rear side of the light guide plate; and
an optical sheet that is arranged on a front side of the light guide plate,
wherein the rear support member, the reflection sheet, and the optical sheet have openings matching an FOV of the infrared camera.

5. The lighting device according to claim 4, wherein the one partial area on a main surface of the light guide plate where the first light distribution control structure is provided has a size greater than or equal to an opening that the reflection sheet has and less than or equal to an opening that the optical sheet has.

6. The lighting device according to claim 4, wherein
the light guide member is arranged on a front side of the optical sheet as a second light guide plate, and
the one partial area on a main surface of the second light guide plate where the second light distribution control structure is provided has a size greater than or equal to an opening that the optical sheet has.

7. The lighting device according to claim 1, wherein
the first light distribution control structure is a first dot pattern, and
the second light distribution control structure is a second dot pattern having a pattern occupancy rate different from a pattern occupancy rate of the first dot pattern.

8. The lighting device according to claim 1, wherein
the first light source includes a plurality of first light emitting elements,
the second light source includes at least one second light emitting element, and
the second light emitting element is controllable to a current value or a luminous flux value that is different from a current value or a luminous flux value of the plurality of first light emitting elements.

9. The lighting device according to claim 2, comprising
an optical functional film that can transmit infrared light and reflect visible light,
wherein the optical functional film has a size sufficient to cover an FOV area of the infrared camera and is arranged at a predetermined position between the infrared camera and the light guide member.

10. The lighting device according to claim 1, comprising
a visible light diffusion film that can transmit infrared light and diffuse visible light,
wherein the visible light diffusion film is arranged on a front side of the light guide plate and the light guide member.

11. The lighting device according to claim 2, wherein
the light guide member includes:
a light incident surface on which visible light from the second light source is incident;
an outer circumferential surface and an inner circumferential surface made of a reflective material;
a light distribution control surface on which the second light distribution control structure is provided; and
a light emitting surface that emits visible light to a front side, and
is arranged adjacent to the infrared camera.

12. A lighting device, comprising:
a first lighting that provides visible light to be emitted from a first area of a light emitting surface;
a second lighting that provides visible light to be emitted from a second area of the light emitting surface, at least a portion of the second area being different from the first area of the light emitting surface; and
an infrared camera capable of performing imaging using infrared light transmitted through the second area,
wherein the second lighting includes a light guide member on which a light distribution control structure, the light distribution control structure reflecting or scattering incident visible light and emitting the visible light in a direction perpendicular to the light emitting surface, is provided corresponding to the second area.

13. A display device, comprising:
the lighting device according to claim 1; and
a display panel that performs display, using visible light from the lighting device.
